(19) United States
(12) Patent Application Publication
(10) Pub. No.: US 2025/0191166 A1
(43) Pub. Date: Jun. 12, 2025

(54) IMAGE INSPECTION SYSTEM

(71) Applicant: CANON KABUSHIKI KAISHA, Tokyo (JP)

(72) Inventor: SAYURI TANABE, Kanagawa (JP)

(21) Appl. No.: 18/967,160

(22) Filed: Dec. 3, 2024

(30) Foreign Application Priority Data
Dec. 7, 2023 (JP) 2023-206752

(51) Int. Cl. G06T 7/00

(52) U.S. Cl. CPC G06T 7/0004; G06T 2207/20021; G06T 2207/20076; G06T 2207/20081; G06T 2207/20084; G06T 2207/30144

(57) ABSTRACT

An image inspection system that inspects an image recorded on a recording medium includes one or more hardware processors; and one or more memories storing one or more programs including instructions for storing a first trained model that is generated by machine learning based on learning recorded images that are images for machine learning, recorded on recording media, storing a second trained model that is generated by machine learning based on recording information that is different from the learning recorded images, acquiring a first probability of a defect being in an actual recorded image, acquiring a first estimation result, acquiring a second probability of a defect being in the actual recorded image; acquiring as a second estimation result and detecting a defect in the actual recorded image on the basis of the first estimation result and the second estimation result.

### BACKGROUND

### Field

The present disclosure relates to an image inspection system.

### Description of the Related Art

An inkjet recording device that discharges liquid such as ink or the like from a liquid discharging head onto a recording medium and records images and the like on the recording medium is a known recording device. In such a recording device, deterioration of recording quality can occur due to various factors such as deviation in attachment position of a recording head, deterioration in ink discharge properties, and so forth.

A detection method that detects defects involved with deterioration in recording quality, such as non-uniformity in image density, image dropout, and so forth, includes a method of acquiring an image of a recorded article and analyzing the image to detect defects. Regarding defects in recorded articles, Japanese Patent Application Publication No. 2021-143884 discloses a method for reducing erroneous detection at the time of performing flaw detection of an image in a recorded article, using machine learning. This method uses image data of the recorded article, or processed data in which this image data has been processed, as input data for machine learning.

However, images recorded by recording devices are widely varied, such as rows of text information, combinations of geometric shapes, photographs of people and scenery, and so forth. Accordingly, in a case of using just image data or processed data thereof as input data as in the above-described method, the precision thereof may deteriorate when detecting defects in images of a nature not learned by machine learning.

### SUMMARY

In light of the foregoing circumstances, recording media is inspected with high precision in the present disclosure.

According to some embodiments, an image inspection system according to the present disclosure includes one or more hardware processors and one or more memories storing one or more programs configured to be executed by the one or more hardware processors, the one or more programs including instructions for storing a first trained model that is generated by machine learning based on learning recorded images that are images for machine learning, recorded on recording media, storing a second trained model that is generated by machine learning based on recording information that is different from the learning recorded images and that is information relating to at least one of the recording device and the recording medium at a time of recording the learning recorded images, acquiring a first probability of a defect being in an actual recorded image that is an object of inspection by the first trained model, acquiring a first estimation result that is an evaluation result regarding whether the actual recorded image is normal or abnormal by a first estimating portion on the basis of the first probability, acquiring a second probability of a defect being in the actual recorded image by the second trained model, acquiring a second estimation result that is an evaluation result regarding whether the actual recorded image is normal or abnormal by a second estimating portion and detecting a defect in the actual recorded image on the basis of the first estimation result and the second estimation result.

According to the present disclosure, recording media can be inspected with high precision.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a processing system;

FIG. 2 is a block diagram illustrating a configuration of a cloud server;

FIG. 3 is a diagram illustrating a device configuration of a printer;

FIG. 4 is a block diagram illustrating a control configuration of the printer;

FIG. 5 is a diagram illustrating a software configuration of the processing system;

FIGS. 6A and 6B are conceptual diagrams illustrating structures of input/output of a learning model and a trained model;

FIGS. 7A and 7B are diagrams illustrating examples of printing image data;

FIG. 8 is a flowchart showing an overview of defect detection according to a first embodiment;

FIG. 9 is a sequence diagram showing operations of the processing system at the time of learning, according to the first embodiment;

FIG. 10 is a flowchart showing a flow for generating learning data, according to the first embodiment;

FIGS. 11A and 11B are flowcharts of image dividing processing and data adjusting processing, according to the first embodiment;

FIG. 12 is an application example of the image dividing processing according to the first embodiment;

FIGS. 13A to 13C are application examples of data adjusting processing according to the first embodiment;

FIGS. 14A to 14C are diagrams illustrating association data of IDs and labels at the time of learning, according to the first embodiment;

FIGS. 15A and 15B are diagrams illustrating a structure of input/output of a learning model at the time of learning, according to the first embodiment;

FIG. 16 is a sequence diagram showing operations of the processing system at the time of estimating, according to the first embodiment;

FIG. 17 is a flowchart showing processing contents of an estimation data generating portion;

FIGS. 18A and 18B are diagrams showing association data of IDs and coordinates information and so forth at the time of estimating;

FIGS. 19A and 19B are diagrams illustrating a structure of input/output of the trained model at the time of estimating;

FIGS. 20A and 20B are explanatory diagrams of an evaluation method carried out by an estimation results evaluating portion;

FIG. 21 is a flowchart showing an overview of defect detection according to a second embodiment; and

FIG. 22 is a flowchart showing an overview of defect detection according to a third embodiment.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments.

Note that in this specification, “recording” may also be referred to as “printing” and is not limited to cases of forming meaningful information such as text, shapes, and so forth, and whether what is formed is meaningful or not is irrelevant. Further, this expression broadly includes cases of forming images such as scenery, people, motifs, patterns, and so forth, on a recording medium, or processing the medium.

Also, “recording medium” is not limited to paper used in general recording devices, and broadly refers to objects that are capable of receiving ink, such as cloth, plastic film, metal plates, glass, ceramics, wood, leather, and so forth.

Also, “ink” (may also be referred to as “liquid”) is to be broadly interpreted, in the same way as the definition of “recording (printing)” above. Accordingly, this represents liquid that is provided so as to form images, motifs, patterns, and so forth, by being imparted upon a recording medium, processing of a recording medium, or processing of ink (e.g., solidification or insolubilization of a colorant contained in ink imparted to a recording medium).

### Processing System

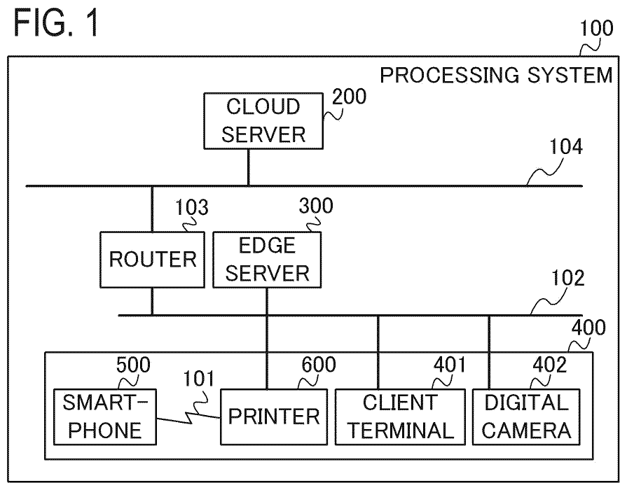

First, a basic configuration of a processing system 100 according to the present disclosure will be described. The basic configuration described below is only an example, and modifications can be made to the configuration contents as appropriate. The processing system 100 is an image inspection system that performs inspection of defects in a recording medium on which an image has been recorded (printed) by a recording device (printing device) such as a printer 600 or the like. FIG. 1 is a diagram illustrating the configuration of the processing system 100. The processing system 100 is made up of a cloud server 200, an edge server 300, and devices 400, which are connected by a local area network 102 and the Internet 104.

Various types of network-connectable devices are included in the devices 400. Examples thereof include a smartphone 500, the printer 600, a client terminal 401 such as a personal computer, a workstation, or the like, a digital camera 402, and so forth. Note however, that the devices 400 are not limited to these types, and may include, for example, home appliances such as a refrigerator, a television, an air conditioner, and so forth.

The various types of devices 400 are connected to each other via the local area network 102, and can connect to the Internet 104 via a router 103 that is installed on the local area network 102. The router 103 is equipment for connecting the local area network 102 and the Internet 104, but can also be provided with a wireless local area network (LAN) access point function making up the local area network 102, so as to make up the processing system 100. In this case, the devices 400 can be configured to, besides connecting to the router 103 by wired LAN, participate in the local area network 102 by accessing and connecting via wireless LAN. Also, a configuration can be made in which, for example, the printer 600 and the client terminal 401 connect by wired LAN, and the smartphone 500 and the digital camera 402 connect by wireless LAN.

The devices 400 and the edge server 300 can mutually communicate with the cloud server 200 via the Internet 104 that is connected via the router 103. The edge server 300 and the devices 400 can mutually communicate with each other via the local area network 102. Also, the devices 400 can mutually communicate with each other via the local area network 102. Also, the smartphone 500 and the printer 600 can communicate by near-field communication 101. For the near-field communication 101, using wireless communication conforming to the Bluetooth (registered trademark) standard or the NFC standard is conceivable.

Note that the configuration of the processing system 100 described above is only an example, and a processing system 100 of a different configuration can be used to carry out the present disclosure. The image inspection system 100 (the image inspection system) can be configured by including one or more hardware processors and one or more memories storing one or more programs configured to be executed by the one or more hardware processors. For example, an example has been described in which the router 103 includes an access point function, but the access point may be configured of a device that is different from the router 103. Also, connection between the edge server 300 and the devices 400 may be an arrangement that uses connecting means other than the local area network 102. For example, arrangements that use wireless communication other than wireless LAN, such as low-power wide area (LPWA), ZIGBEE (registered trademark), Bluetooth (registered trademark), near-field communication, or the like, wired connection such as Universal Serial Bus (USB) or the like, or infrared communication or the like, may be employed.

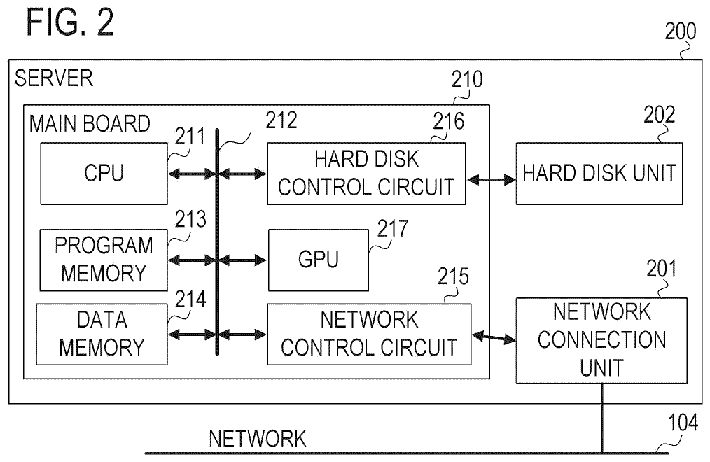

FIG. 2 is a block diagram illustrating a configuration of the cloud server 200. In the present configuration, a common hardware configuration is used for the cloud server 200 and the edge server 300. Accordingly, the configuration of the cloud server 200 will be described below, and description of the configuration of the edge server 300 will be omitted.

The cloud server 200 is made up of a main board 210 that performs control of the entire device, a network connection unit 201, and a hard disk unit 202. A central processing unit (CPU) 211 in a form of a microprocessor that is disposed on the main board 210 operates in accordance with control programs stored in program memory 213 connected via an internal bus 212, and contents of data memory 214.

The CPU 211 controls the network connection unit 201 via a network control circuit 215, thereby connecting to networks such as the Internet 104, the local area network 102, and so forth, and performs communication with other devices. The CPU 211 can read and write data from and to the hard disk unit 202 connected via a hard disk control circuit 216.

The hard disk unit 202 stores an operating system that is loaded to the program memory 213 and used, control software for the cloud server 200 and the edge server 300, and furthermore stores various types of data as well.

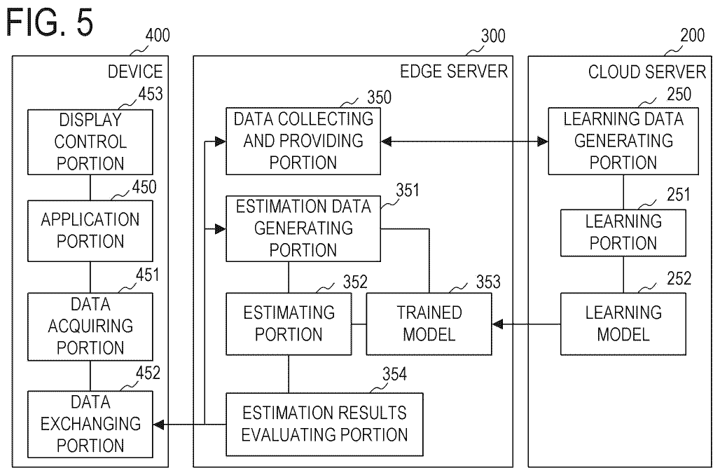

A graphics processing unit (GPU) 217 is connected to the main board 210, and can be made to execute various types of computation processing in place of the CPU 211. The GPU 217 can perform efficient computation by performing a greater amount of parallel processing of data, and accordingly, performing processing using the GPU 217 in a case of repeatedly performing learning using a learning model, such as in deep learning, is effective. Accordingly, in the present configuration, the GPU 217 is used in addition to the CPU 211 for processing by a learning portion 251 (see FIG. 5), which will be described later. Specifically, in a case of executing a learning program including a learning model, learning is performed by the CPU 211 and the GPU 217 collaboratively performing computation. Note that for processing of the learning portion 251, computation may be performed by just one of the CPU 211 and the GPU 217. Also, an estimating portion 352 (see FIG. 5) may also use the GPU 217, in the same way as with the learning portion 251.

Also, while the cloud server 200 and the edge server 300 have been described in the present configuration as using a common hardware configuration, carrying out the present disclosure is not necessarily limited to this configuration. For example, a configuration may be made in which the cloud server 200 is equipped with the GPU 217 but the edge server 300 is not equipped therewith, and may be configured using a GPU 217 of different performance.

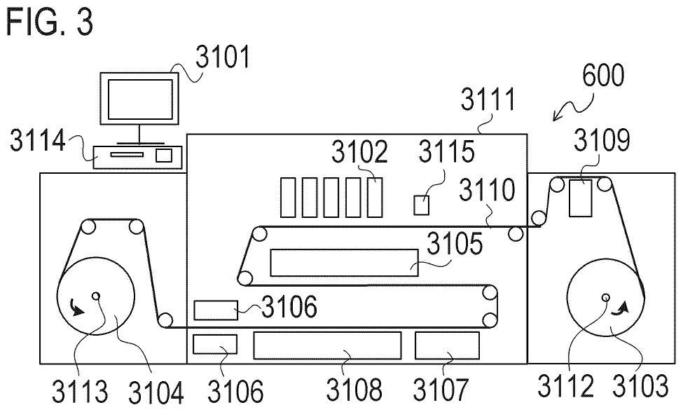

FIG. 3 is a diagram illustrating a device configuration of the printer 600 according to the present configuration. The printer 600 is a recording device that prints on continuous paper (hereinafter “roll paper”) 3110 that is capable of receiving continuous printing as a recording medium. In the present configuration, the printer 600 is configured including a paper feeding device 3103 that conveys the roll paper 3110. Further, the printer 600 is configured including a printing portion 3111 that performs printing, a paper discharging device 3104 that takes up the roll paper 3110, and an operating panel 3101.

The paper feeding device 3103 is a device that supplies the roll paper 3110 to the printer 600. The paper feeding device 3103 rotates a paper core of the roll paper 3110 about a rotational shaft 3112, so as to convey the roll paper 3110 wound upon the paper core toward the printer 600 at a constant speed, over a plurality of rollers (conveying roller, paper feeding roller, and so forth).

The paper discharging device 3104 is a device that takes up the roll paper 3110, conveyed from the printer 600, about a paper core in a roll. At the paper discharging device 3104, as illustrated in FIG. 3, the roll paper 3110 is wound upon the paper core of a rotational shaft 3113 and is held in a roll, for example. The paper discharging device 3104 is a device that rotates the paper core about the rotational shaft 3113 and takes up the roll paper 3110 conveyed thereto over the plurality of rollers (conveying roller, paper discharging roller, and so forth), onto the rotational shaft 3113 at a constant speed, as a product of the roll paper.

As preparation prior to starting printing, the roll paper 3110 is fed out from the paper feeding device 3103, run over the route up to the paper discharging device 3104, and set in the printer 600. In setting operations of the roll paper 3110, first, the roll paper 3110 is set in the paper feeding device 3103, and a leading edge of the roll paper 3110 is passed over a skew correcting device 3109. Next, the leading edge of the roll paper 3110 is passed below a printing device 3102 of the printing portion 3111, passed below a drying device 3105, and passed over a cooling device 3107 and a cooling device 3108. The leading edge of the roll paper 3110 is then passed through a connected scanner device 3106, and wound upon the paper discharging device 3104. After the roll paper 3110 is passed through the printer 600 and set, a print job is entered into a controlling personal computer (PC) 3114 of the printer 600. Pressing a printing start button from the operating panel 3101 after entering the print job starts printing.

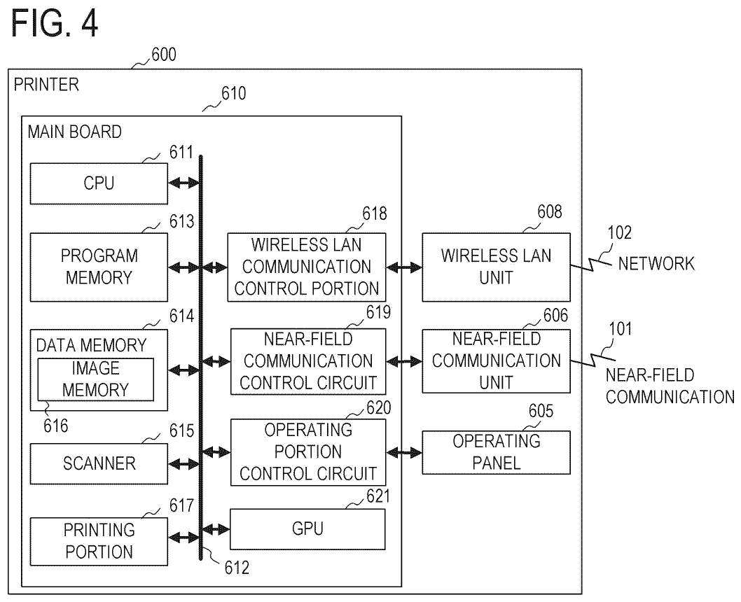

FIG. 4 is a block diagram illustrating a control configuration of the printer 600. The printer 600 is made up of a main board 610 that performs control of the entire device, a wireless LAN unit 608, and a near-field communication unit 606. A CPU 611 in a form of a microprocessor that is disposed on the main board 610, operates in accordance with control programs stored in program memory 613 in a form of read-only memory (ROM) that is connected via an internal bus 612, and contents of data memory 614 in a form of random access memory (RAM).

The CPU 611 controls a scanner portion 615 to read an original document, and stores image data of the original document in image memory 616 in the data memory 614. The CPU 611 can also control a printing portion 617 to print the image in the image memory 616 within the data memory 614 onto the recording medium. The CPU 611 performs wireless LAN communication with other communication terminal devices by controlling the wireless LAN unit 608 through a wireless LAN communication control portion 618.

Also, the CPU 611 can detect connection of other near-field communication terminals, and exchange data with other near-field communication terminals by controlling the near-field communication unit 606 via a near-field communication control circuit 619.

The CPU 611 can display a state of the printer 600 or display a function selection menu on an operating panel 605, accept operations from a user, and so forth, by controlling an operating portion control circuit 620. The operating panel 605 is equipped with a backlight, and the CPU 611 can control whether the backlight is turned on or off via the operating portion control circuit 620. Turning the backlight off makes the display of the operating panel 605 less easy to see, but electric power consumption of the printer 600 can be suppressed. Note that in the present configuration, processing of the above-described CPU 611 can also be performed by a GPU 621.

FIG. 5 is a diagram illustrating a software configuration of the processing system 100. FIG. 5 illustrates, out of software configurations, only those related to the processing of learning and estimation according to the present configuration, and other software modules are omitted from illustration. For example, operating systems that run on the devices and the servers, various types of middleware, applications for maintenance, and so forth, are omitted from illustration.

The cloud server 200 is equipped with a learning data generating portion 250, the learning portion 251, and a learning model 252. The learning data generating portion 250 is a module that generates learning data that the learning portion 251 is capable of processing, from data that is externally received. The learning data is a set of input data 801 that is input to the learning portion 251 and teaching data 802 indicating correct answers for results of learning. The learning portion 251 is a program module that executes learning of the learning model 252, with respect to the learning data received from the learning data generating portion 250. The learning model 252 accumulates results of learning performed by the learning portion 251. An example in which the learning model 252 is realized as a neural network will be described here. Optimizing weighting parameters among the nodes of the neural network enables input data to be classified, evaluation values to be decided, and so forth. The learning model 252 that is accumulated is distributed to the edge server 300 as a trained model, and is used for estimation processing at the edge server 300.

The edge server 300 is equipped with a data collecting and providing portion 350, an estimation data generating portion 351, the estimating portion 352, a trained model 353, and an estimation results evaluating portion 354. The data collecting and providing portion 350 is a module that transmits data received from the devices 400 and data that the edge server 300 itself has collected, to the cloud server 200 as a data group, to be used for learning. The estimation data generating portion 351 is a module that generates estimation data that is processable by the estimating portion 352, on the basis of data sent from the devices 400. The estimating portion 352 is a program module that executes estimation using the trained model 353, on the basis of estimation data received from the estimation data generating portion 351. The estimation results evaluating portion 354 returns the estimation results received from the estimating portion 352 to the device 400 upon final evaluation thereof. The data that is sent from the device 400 and that is generated at the estimation data generating portion 351 is data to serve as the input data 801 that is input to the estimating portion 352.

The trained model 353 is used for estimation performed at the edge server 300. The trained model 353 is also realized as a neural network, in the same way as the learning model 252. Note however, that the trained model 353 may be the same as the learning model 252, or part of the learning model 252 may be extracted and used, which will be described later. The trained model 353 stores the learning model 252 that is accumulated at the cloud server 200 and distributed. The trained model 353 may be all of the learning model 252 distributed, or may be just part of the learning model 252 necessary for estimation at the edge server 300 that is extracted and distributed.

The devices 400 are each equipped with an application portion 450, a data acquiring portion 451, a data exchanging portion 452, and a display control portion 453. The application portion 450 is a module that realizes various types of functions executed at the device 400, and is a module that uses a framework of learning and estimation by machine learning. The display control portion 453 is a module that controls display of the application portion 450. The data acquiring portion 451 can acquire all sorts of data that the printer 600 can hold, such as image data acquired at the scanner portion 615 and saved in the image memory 616, information of sensors belonging to the printing portion 617, saved in the data memory 614, and so forth. The data exchanging portion 452 is a module that requests the edge server 300 to perform learning or estimation. At the time of learning, data to be used for learning is transmitted to the data collecting and providing portion 350 of the edge server 300 under request by the application portion 450. Also, at the time of estimating, data to be used for estimation is transmitted to the edge server 300 under request by the application portion 450, and the results thereof are received and returned to the application portion 450.

Note that while a form has been described in the present configuration in which the learning model 252 that has performed learning at the cloud server 200 is distributed to the edge server 300 as the trained model 353, so as to be used for estimation, this form is not limiting. The configuration of which of the cloud server 200, the edge server 300, and the devices 400 to execute each of learning and estimation can be decided in accordance with allocation of hardware resources, amount of calculations, and magnitude of data communication amount. Alternatively, a configuration may be made that is dynamically changed in accordance with allocation of such resources, amount of calculations, and increase/decrease of data communication amount. In a case that entities performing learning and estimation are different, the estimating side can reduce the capacity of logic and the trained model 353 used only for estimation, so as to be configured to enable execution at higher speeds, and so forth.

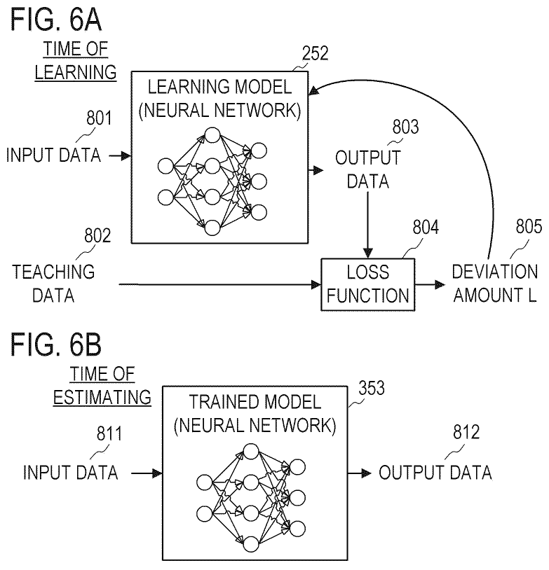

Next, structures of input/output of the learning model 252 and the trained model 353 will be described in detail. FIGS. 6A and 6B are conceptual diagrams illustrating structures of input/output at the time of using the learning model 252 and the trained model 353.

FIG. 6A illustrates a relation between the learning model 252 and input/output data thereof at the time of learning. The input data 801 is data of an input layer of the learning model 252. Details of the input data 801 of the learning model 252 will be described later. Output data 803 is output as the result of evaluating (recognizing) the input data 801 using the learning model 252 that is a machine learning model. At the time of learning, the teaching data 802 is provided as correct answer data for evaluation results of the input data 801, and accordingly providing the output data 803 and the teaching data 802 to a loss function 804 yields deviation amount L (805) of the recognition results from the correct answer. Junction-weighting coefficients among nodes of the neural network in the learning model 252, and so forth, are updated, such that the deviation amount L is minimized with regard to a great number of learning data. Backpropagation is a technique for adjusting the junction-weighting coefficients among nodes of the neural network, and so forth, so that the above error is smaller. Specific examples of algorithms for machine learning include nearest neighbor, naive Bayes, decision tree, support-vector machine, and so forth. Another example is deep learning, in which a neural network is used to generate features for learning and junction-weighting coefficients by itself. In the present configuration, the algorithm for machine learning can be selected and used from the above as appropriate.

FIG. 6B illustrates a relation between the trained model 353 and input/output data thereof at the time of estimation. Input data 811 is data of an input layer of the trained model 353. Details of the input data 811 of the trained model 353 will be described later. Output data 812 is output as the results of recognizing the input data 811 using the trained model 353 that is a machine learning model. At the time of estimation, this output data 812 is used as estimation results. Note that while the trained model 353 at the time of estimation has been described as being equipped with a neural network that is equal to that of the learning model 252 at the time of learning, but an arrangement in which only portions necessary for estimation are extracted can be prepared as the trained model 353. This enables the data amount of the trained model 353 to be reduced, and the neural network processing time at the time of estimation to be reduced.

In a recording device such as the printer 600, there is concern that recording quality will deteriorate due to various factors, and defects will occur in recorded articles (printed articles). For example, in inkjet recording devices that perform recording operations by discharging liquid such as ink or the like from a liquid discharge head, error may occur an attachment position of a recording head, or in relative attachment positions among a plurality of recording heads. Such error causes deviation in ink landing positions on the recording medium, and is a factor in deterioration in recording quality. Also, manufacturing error and so forth in recording heads may include variance in discharge characteristics such as discharge amount and so forth, among a plurality of nozzles. This variance causes non-uniformity in image density, which also is a factor in deterioration in recording quality. Further, causes in which discharge from the nozzles is not good also is a factor in deterioration in recording quality.

Conventionally, special printing patterns have been used as a method for detecting defects in recorded articles due to such deterioration in recording quality. For example, deterioration in recording quality can be detected by reading a special printing pattern using a reading device such as a scanner or the like, and verifying whether the printing pattern is correctly printed. However, comprehensively detecting all defects in recorded articles that can occur due to various factors by such a method is extremely difficult. Also, ink and time are consumed to print the printing pattern. Accordingly, in the present configuration, machine learning results at the learning portion 251 and the learning model 252 are used in order to suppress deterioration in productivity of the recording device, and perform highly precise detect detection of recorded articles. Next, a specific method of performing detect detection of printed articles printed by the printer 600, using the processing system 100 configured such as described above, will be described over a plurality of embodiments.

### First Embodiment

A method for estimating and detecting defects in printed articles of the printer 600 by the processing system 100 including machine learning means will be described as a first embodiment of the present disclosure.

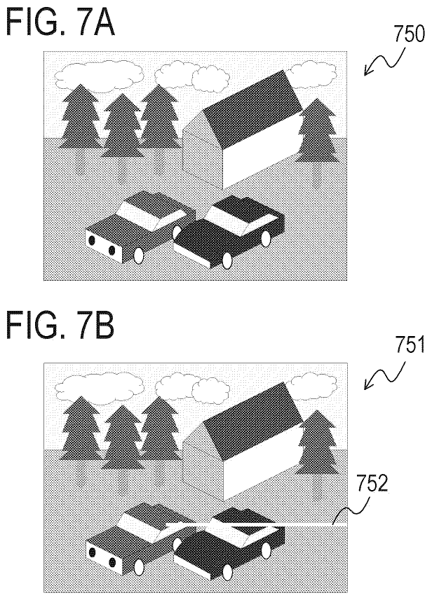

FIGS. 7A and 7B are examples of image data, in which a printed article printed by the printing portion 617 has been acquired by the scanner portion 615 and saved in the image memory 616. Hereinafter, such an image will be referred to as “printing image data”. That is to say, printing image data is a recorded image recorded on a recording medium that has been acquired by a scanner or the like. Printing image data 750 in FIG. 7A is printing image data of a printed article that has been correctly printed. Printing image data 751 in FIG. 7B is printing image data of a printed article that includes a defect portion 752 and that has not been correctly printed. Examples of defects at the time of printing (time of recording) include dropouts due to non-discharge of ink, recording position deviation due to head attachment error or the like, difference in how well ink is discharged, color non-uniformity due to unevenness, and so forth. Dropouts due to non-discharge of ink cause blank regions such as the defect portion 752 in FIG. 7B. Further, there is a possibility that defects will occur in the printed article due to tearing or the like of the roll paper 3110 itself. Other defects are not illustrated, but defects that are the object of detection in the present disclosure are not limited to dropouts due to non-discharge of ink.

The present disclosure estimates and detects defects in printed articles by a trained model that takes printing image data which are learning recorded images for machine learning as input. However, contents of printed articles are varied, and while there are those with scenery such as illustrated in FIG. 7A, there can be illustrations, text, barcodes, and so forth. For example, in a case of a printed article that is a geometric illustration, there are cases in which blank regions such as the defect portion 752 in FIG. 7B are included as part of the design, and are correct regions. That is to say, in a trained model that has learned that the defect portion 752 in FIG. 7B is an abnormality may erroneously determine a blank region in an illustration as being a defect. Further, precision of trained modules from machine training generally cannot be said to be 100% guaranteeable. In light of the above, the present disclosure provides a method for estimating and detecting defects in printed articles by a trained model taking printing image data as input, in which erroneous determination is prevented by additionally using a trained model that takes different data from the printing image data as input, and more accurate results are obtained.

In the first embodiment, different data from the printing image data used for detecting defects in printed articles is data relating to potential causes of defects in printed articles in the printer 600. More specifically, different data from the printing image data used for detecting defects in printed articles is recording information relating to the printer 600 at the time of printing printed articles and the roll paper 3110 that is the recording medium (media). For example, nozzle clogging that is a cause of non-discharge occurs due to various factors, such as long cumulative printing time, left standing for a long period of time left standing without protecting the nozzles by a cover or the like, infrequent cleaning of the nozzles, high ink concentration, and so forth. Accordingly, cumulative printing time, amount of time without protecting the nozzles by a cover or the like, count of times of nozzle cleaning, ink concentration, and so forth, can be taken as input data.

Also, a cause of deviation in recording position is change in the fixed position of the recording head itself in the printer 600. Accordingly, position information such as detecting sensor values and so forth regarding the position of the recording head, for example, can be taken as input data. The position of the recording head can be obtained by installing a distance sensor in the device side, and acquiring distance to the position of a certain part of the recording head, or the like.

Also, a cause of deviation in recording position is change in the conveying distance and speed of the media (recording medium) such as the roll paper 3110 or the like. When the conveying speed of the media changes, the position becomes deviated from the discharge timing for ink of each color that had been optimized in advance, resulting in recording position deviation. A cause of change in conveying speed of the media is defects in parts making up a conveying path, and with control. Accordingly, sensor values capturing change in shapes of parts, values such as environment temperature (ambient temperature) and environment humidity that can cause change in the shapes of parts, and so forth, can be taken as input data.

An example of parts making up the conveying path is conveying rollers. Disposing distance sensors or the like in the proximity of the rollers enable change in diameter of the rollers to be captured. In the case of media that is roll paper in particular, the media itself is conveyed while being wound upon the feeding side and the discharging side, and accordingly conveying precision can be affected by change in nature of the media due to difference in the type of media, and difference in moisture content in accordance with humidity. Accordingly, parameters that decide the media type (name of sheet type, material, size, thickness coating type, and so forth) can be taken as input data.

Also, a cause of how well the ink is being discharged can be the same as the cause of non-discharge. Note that while examples of data that differs from the printing image data has been described here, out of the data used as input data, any data relating to potential causes of defects in printed articles in the printer 600 can be taken as input data, even though not described above.

As described above, results of machine learning that takes two or more types of input data are used in the first embodiment, and accordingly two types of the learning model 252, the trained model 353, and the estimating portion 352 are included. In the following description, of the learning models 252, that which takes printing image data as input will be referred to as “first learning model”, and that which takes data that differs from printing image data as input as “second learning model”. In the same way, in the following description, of the trained models 353, that which takes printing image data as input will be referred to as “first trained model”, and that which takes data that differs from printing image data as input as “second trained model”. In the same way, in the following description, of the estimating portions 352, that which uses machine learning results of the first trained model will be referred to as “first estimating portion”, and that which uses machine learning results of the second trained model as “second estimating portion”. Other matters relating to machine learning are also described by being distinguished by “first” and “second” as necessary. Note however, that the first learning model and the second learning model may make up a single learning model 252, and the estimating portion 352 may be a single estimating portion that is used in common.

### Flow for Detecting Defects in Printed Articles

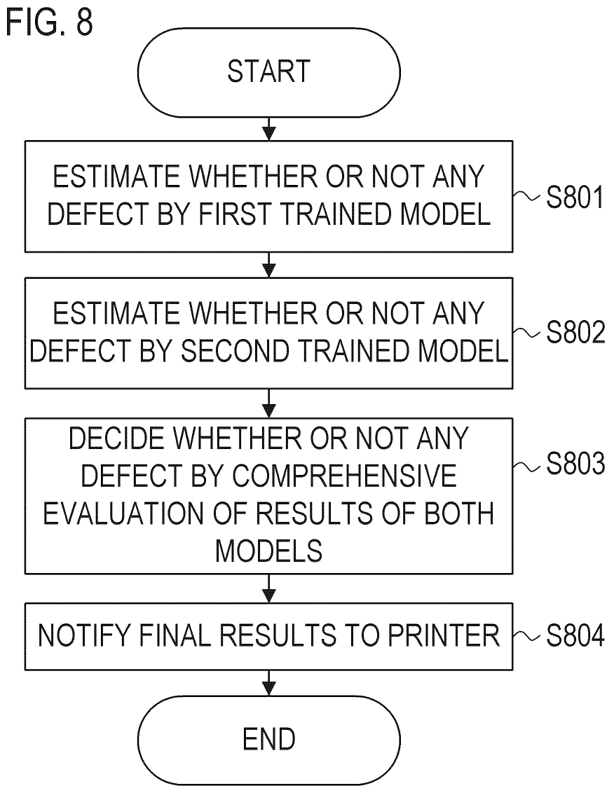

Next, a processing flow for detecting defects in printed articles (actual printing results) of the printer 600 by the processing system 100 according to the first embodiment will be described. FIG. 8 is a flowchart illustrating an overview of defect detection performed by the processing system 100.

First, in step S801, whether or not there is a defect in printing image data is estimated by the first trained model that takes, as input thereof, the printing image data that is image data obtained by scanning an actual printed image (actual recorded image) of an actual printed article (actual recorded medium) printed by the printer 600. That is to say, a first estimating portion uses the first trained model to acquire first estimation results regarding whether or not there is a defect in the actual recorded image of the actual printed article that is the object of inspection, on the basis of the printing image data. Upon step S801 ending, the flow advances to step S802.

In step S802, whether or not a defect occurred at the time of printing is estimated by the second trained model that takes, as input thereof, data that differs from the printing image data described above, as various types of parameters regarding when printing the actual printed article. That is to say, a second estimating portion uses the second trained model to acquire second estimation results regarding whether or not there is a defect in the actual recorded image of the actual printed article that is the object of inspection, the basis of the data that differs from the printing image data. As described above, the data that differs from the printing image data is recording information relating to the printer 600 and to the roll paper 3110 that is the recording medium. Upon step S802 ending, the flow advances to step S803.

In step S803, final decision of whether or not there is a defect in the printed article is made from the estimation results in step S801 and step S802. Here, the final estimation results regarding whether or not there is a defect in the printed article are acquired by the estimation results evaluating portion 354 on the basis of the first estimation results and the second estimation results. Upon step S803 ending, the flow advances to step S804.

In step S804, the printer is notified of whether or not there is a defect in the printed article serving as a basis of the printing image data and so forth. Hereinafter, learning for obtaining the trained models for carrying out these steps, estimation using the trained models, and final decision of whether or not there is a defect, using the results of both models, will be described in detail. Note that while an example of carrying out two estimations in series is described in FIG. 8, this may be carried out in parallel.

### Operations of Processing System at Time of Learning

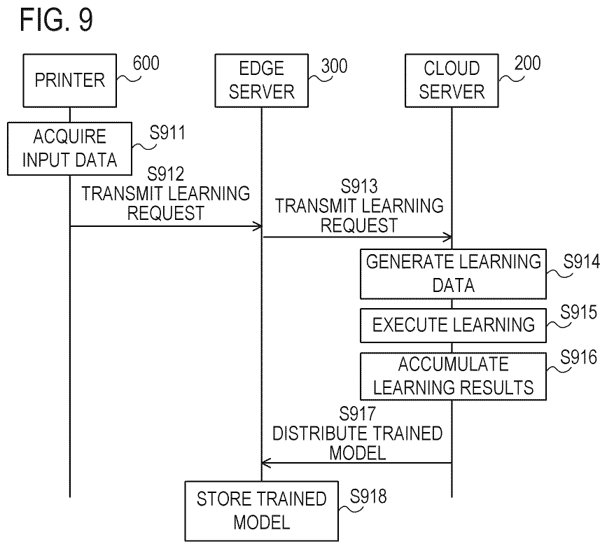

Next, the operations of the processing system 100 at the time of learning will be described. FIG. 9 is a sequence diagram showing operations of the overall processing system 100 at the time of learning. This sequence is held in common between a case in which the first trained model that takes printing image data as input data is generated, and a case in which the second trained model that takes, as input data, data that differs from the printing image data at the time of printing the printed article on which the printing image data is based, is generated.

In step S911, the printer 600 acquires input data that is the object of learning. The object of learning at the time of generating the first trained model is printing image data of all actual printed articles printed by the printer 600.

The object of learning at the time of generating the second trained model is various types of parameters at the time of printing the actual printed articles on which the printing image data input to the first trained model is based. The object of learning at the time of generating the second trained model is acquired in a format such as log data, including such information in a period corresponding to a point in time of starting printing of the actual printed article to a point in time of ending the printing. The various types of parameters data are preferably recorded one or more times during the printing time. Also, while the various types of parameters data are preferably recorded all at the same cycle, the cycle may be different for each parameter. For example, in a case in which the printing speed is one print per second, the various types of parameters data are preferably recorded at a cycle of one time or more per second. Also, the printing time information of each printed article may be included in the various types of parameter data, or may be acquired separately from the various types of parameters data and associated with the various types of parameters data at a later time.

Upon the input data being acquired, in step S912, a learning request is transmitted from the printer 600 to the edge server 300. Next, in step S913, the edge server 300 that has received the learning request from the printer 600 transmits the learning request to the cloud server 200.

In step S914, the cloud server 200 that has received the learning request generates learning data by the learning data generating portion 250, from the learning request that is received. Details of generating learning data will be described later. Next, in step S915, learning is executed by the learning portion 251 (first learning portion and second learning portion). Next, in step S916, the learning model 252 (first learning model and second learning model) is updated on the basis of the machine learning results, which are accumulated.

Upon the learning by the learning portion 251 and accumulation of the learning results ending, in step S917 the cloud server 200 generates the trained model 353 (first trained model and second trained model) to be distributed to the edge server 300 from the learning model 252, and performs distribution thereof. The edge server 300 that has received the trained model 353 distributed in step S917 performs reflecting thereof in its own trained model 353 in step S918, and performs storage thereof. Thus, estimation requests thereafter are performed using the trained model 353 that has been updated.

When performing first trained model generation and second trained model generation, step S911 may be started at the same timing, or the second trained model generation may be started at the point in step S916 or step S918 at which the first trained model generation is completed. The timing for starting suitably is a point at which data that has not been learned is accumulated, such as a point at which generating of one new piece of printing image data is completed, a point at which generating printing image data of grouped printed articles is completed, or a point at which accumulation of printing image data is performed within an optional period such as one day, or the like. In a case in which constantly learning new printed article data and updating the trained models are desired, acquiring can be performed at a point in time at which generating of one new price of printing image data is complete. Also, timings of generating and updating the trained models may be automatic or manual.

### Learning Data Generating Flow

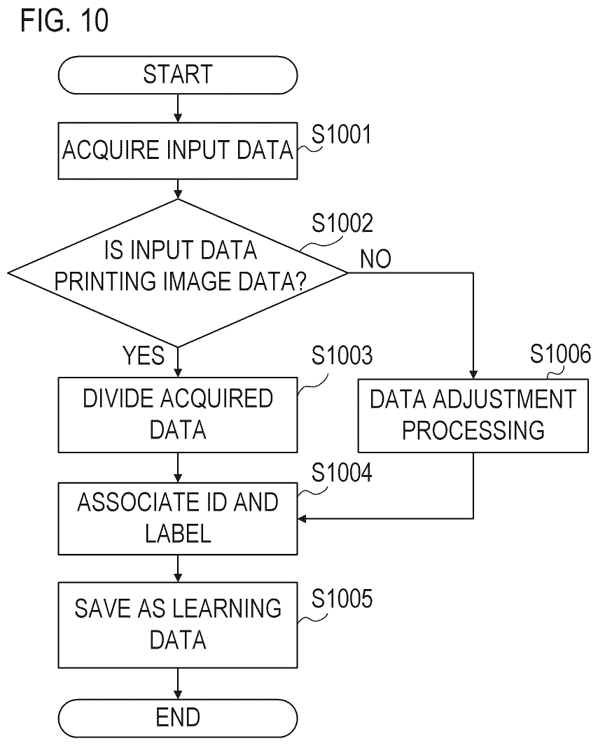

Next, a learning data generating flow for generating learning data by the learning data generating portion 250 will be described. FIG. 10 is a flowchart showing the learning data generating flow regarding which the learning data generating portion 250 performs processing. Upon acquiring input data in step S1001, in step S1002 the learning data generating portion 250 confirms contents of the input data, and performs determination regarding whether or not the input data is printing image data for the first trained model generation. In a case in which the input data is printing image data, i.e., YES is returned in step S1002, the flow advances to step S1003. In a case in which the input data is not printing image data, i.e., NO is returned in step S1002, the flow advances to step S1006. Now, a case in which the input data is not printing image data is a case in which, for example, the input data is data including various types of parameter data for second trained model generation.

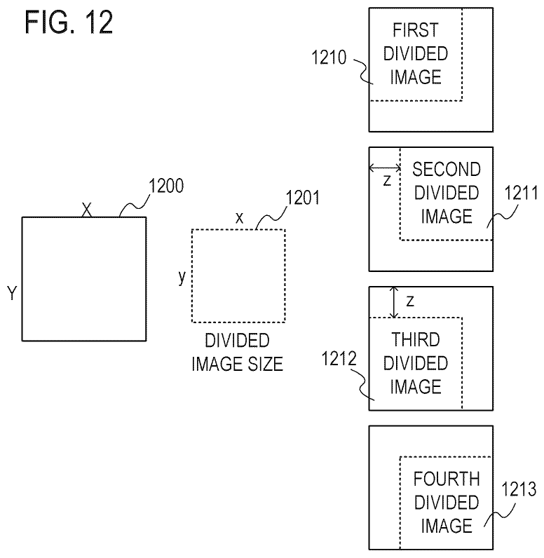

In step S1003, the acquired printing image data is divided. Dividing the image enables just divided image data of a region where there is a defect to be learned as abnormal data, and divided image data of regions where there are no defects to be learned as normal data, out of the entire image. Dividing the image in this way expands learning data as compared to a case of taking the printing image data itself as one piece of learning data. Also, when a defect is detected in the printing image data itself that is not divided, where in the printing image data the defect is situated cannot be clarified. Accordingly, dividing the image enables the position of the defect region to be comprehended in the entire image at the time of estimating. The divided image data is the input data 801 to the learning model 252 at the time of first trained model generation. Details of dividing processing will be described later with reference to FIG. 12. Upon step S1003 ending, the flow advances to step S1004.

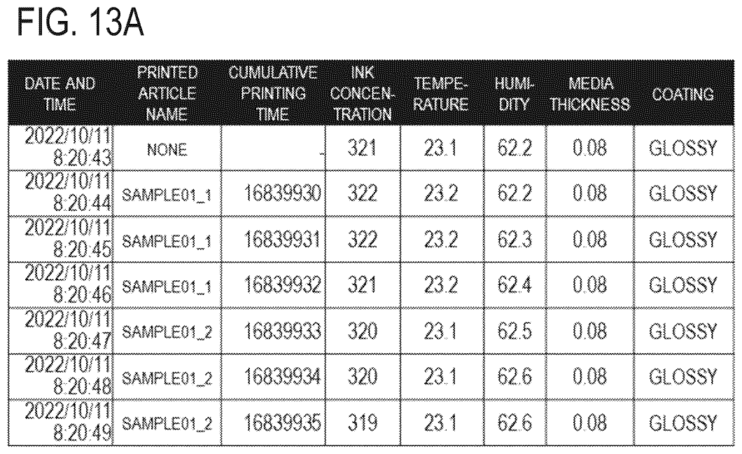

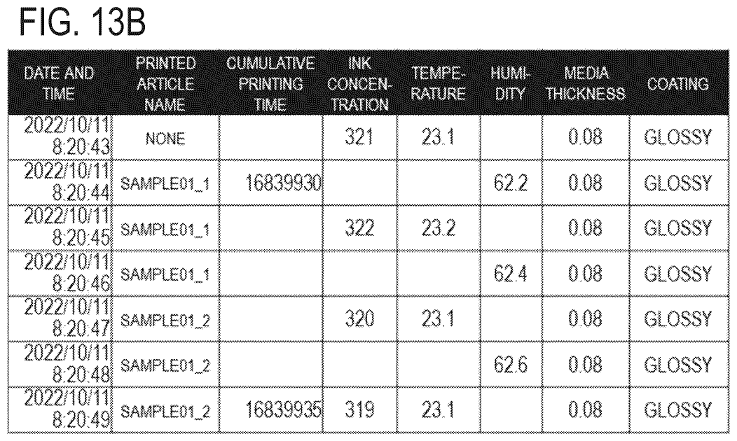

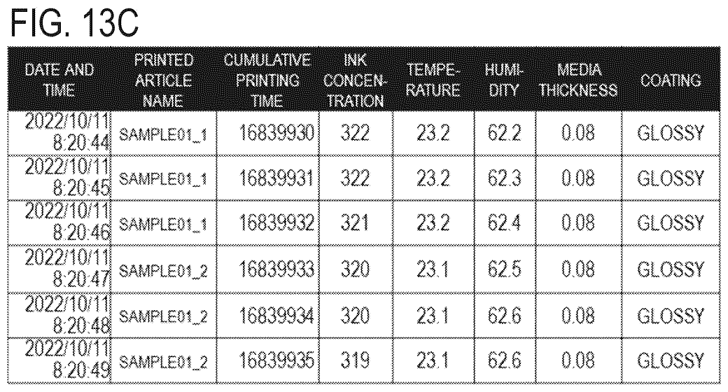

In step S1006, adjustment processing of the various types of parameter data that are acquired is performed. Data adjustment processing will be described later with reference to FIGS. 13A to 13C. Data following adjustment processing becomes the input data 801 input to the learning model 252 at the time of second trained model generating. Upon step S1006 ending, the flow advances to step S1004.

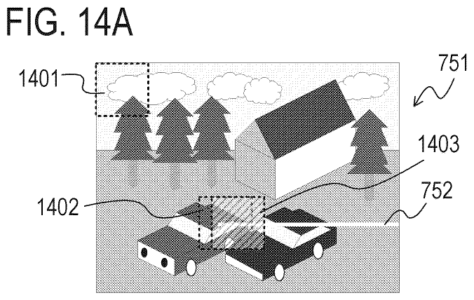

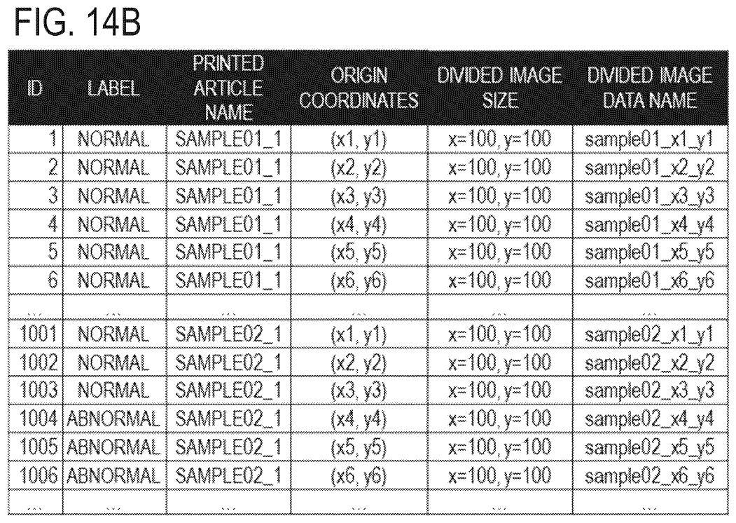

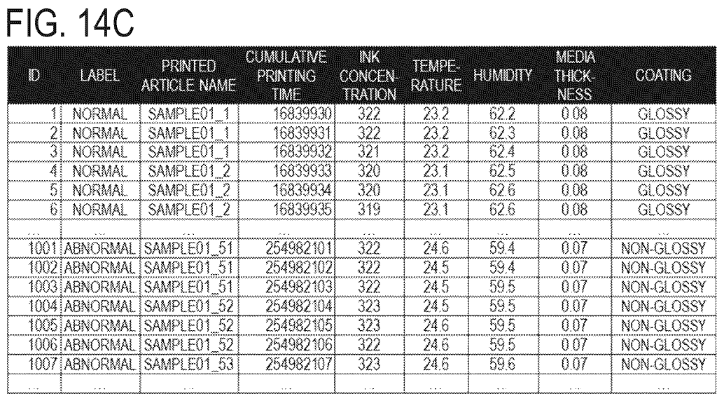

In step S1004, the learning data generating portion 250 associates an ID of each piece of data with a label. The label that is association data associated with the ID is the teaching data 802 for the learning model 252. Association of IDs and labels will be described later with reference to FIGS. 14A to 14C. Upon step S1004 ending, the flow advances to step S1005, and in step S1005, the learning data generating portion 250 saves the association data of each piece of data, and ID and label, as learning data. Processing Flow of Learning Data Generating Portion

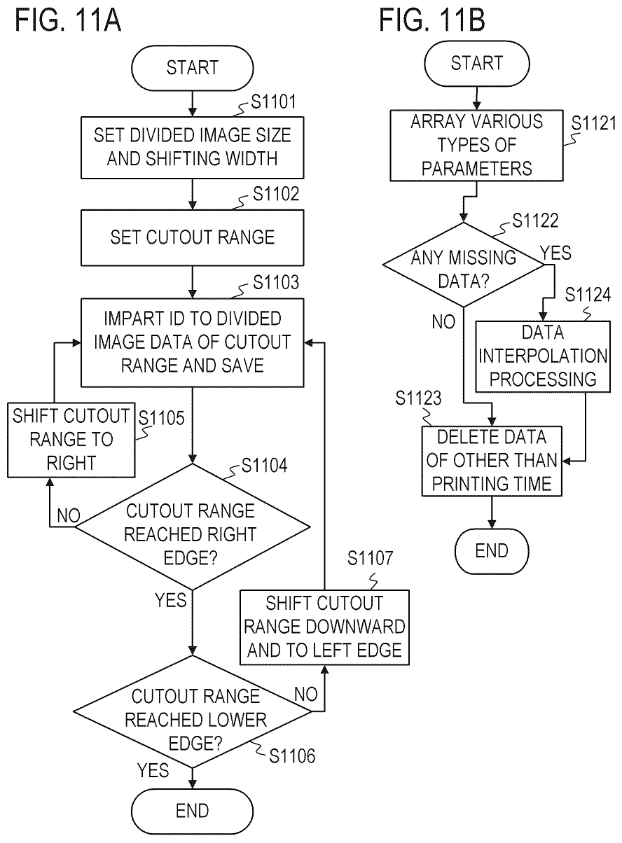

Next, each processing flow (image dividing processing and data adjustment processing) by the learning data generating portion 250 will be described. FIGS. 11A and 11B are flowcharts of processing performed by the learning data generating portion 250.

### Image Dividing Processing Flow

FIG. 11A is a processing flow of image dividing. In step S1101, the learning data generating portion 250 sets a divided image size (lateral width x, vertical width y) and shifting width z. Next, in step S1102 the learning data generating portion 250 sets a region of the divided image size as a cutout range, with an upper left of the printing image data as an origin. Then in step S1103, a divided image of the cutout range is created, an ID is imparted thereto, and saved. It is sufficient for the ID to be content by which each divided image can be uniquely associated with, by numerical values or text strings.

In step S1104, the learning data generating portion 250 determines whether or not a right edge of the cutout range has reached a right edge of the printing image data in step S1103. In a case in which the right edge of the cutout range has not reached the right edge of the printing image data, i.e., NO is returned in step S1104, the flow advances to step S1105. In a case in which the right edge of the cutout range has reached the right edge of the printing image data, i.e., YES is returned in step S1104, the flow advances to step S1106.

In step S1105, the learning data generating portion 250 shifts the cutout range to the right by the shifting width z. Thereafter, the flow advances to step S1103, and the divided image data for the cutout range is saved in step S1103 again. The learning data generating portion 250 repeats this processing until the right edge of the cutout range reaches the right edge of the printing image data.

In step S1106, the learning data generating portion 250 determines whether or not a lower edge of the cutout range has reached a lower edge of the printing image data. In a case in which the lower edge of the cutout range has not reached the lower edge of the printing image data, i.e., NO is returned in step S1106, the flow advances to step S1107. In a case in which the lower edge of the cutout range has reached the lower edge of the printing image data, i.e., YES is returned in step S1106, the processing ends.

In step S1107, the learning data generating portion 250 shifts the cutout range downward by the shifting width z, and also shifts the cutout range to a left edge. Thereafter, the flow advances to step S1103, and the divided image data for the cutout range is saved in step S1103 again. Eventually, a lower right edge of the cutout range reaches a lower right edge of the printing image data, whereby the entire range of the printing image data is saved as divided image data, and the learning data generating portion 250 ends the processing.

Note that while the shifting width z is the same value here between a case of shifting to the right and a case of shifting downward, but the shifting width z may be different values between the case of shifting to the right and the case of shifting downward, as long as the shifting width z is smaller than the divided image size (lateral width x and vertical width y).

Also, while description has been made regarding the processing flow of image dividing by way of an example in which the shifting width z is set to a value where the lateral width x and the vertical width y of the printing image data are divisible by the shifting width z, this may be an indivisible value. In this case, the range of the printing image data will be exceeded as a result of shifting to the right or downward in the processing of step S1105 and step S1107. In such a case, a configuration is suitable in which the learning data generating portion 250 adds processing to perform correction of the shifting width z in step S1105 and step S1107 such that the range of the size of the printing image data is not exceeded.

### Data Adjustment Processing Flow

FIG. 11B is the data adjustment processing flow. In step S1121, the learning data generating portion 250 arrays the various types of parameters, and performs data ordering. Specifically, the data is ordered into a format in which the various types of parameters are arrayed by point in time. After arraying the various types of parameters, the flow advances to step S1122.

In step S1122, the learning data generating portion 250 confirms whether or not there is missing data at each printing point in time during the printing time in which the data was collected. For example, in a case in which a recording cycle of predetermined data is longer as to the cycle of the printing time for acquiring data, there can be cases in which this predetermined data does not exist (not successfully acquired) at a certain printing pint in time. In a case in which there is such missing data or flawed data, i.e., in a case in which YES is returned in step S1122, the flow advances to step S1124. In a case in which there is no missing data, i.e., in a case in which NO is returned in step S1122, the flow advances to step S1123.

In step S1124, the learning data generating portion 250 performs data interpolation processing. In data interpolation processing, processing for interpolating missing data is performed. Details of data interpolation processing will be described later. Upon the data interpolation processing in step S1124 ending, the flow advances to step S1123.

In step S1123, the learning data generating portion 250 deletes data of other than the printing time, i.e., data of points in time at which no printing was being performed and evaluation of the printed article cannot be made. Thereafter, the processing ends.

Next, an example of image dividing processing by the learning data generating portion 250 will be described. FIG. 12 is an application example of the image dividing processing. FIG. 12 illustrates the way in which one piece of printing image data 1200 is divided into four divided images, which are a first divided image 1210, a second divided image 1211, a third divided image 1212, and a fourth divided image 1213.

The example illustrated in FIG. 12 is a case in which four divided images (1210, 1211, 1212, 1213) are obtained in order, by specifying a divided image size 1201 of lateral width x and the vertical width y, and the shifting width z, and processing the printing image data 1200 of lateral width X and vertical width Y. Although an example in which four divided images are obtained is illustrated in FIG. 12, the number of divided images that are obtained changes depending on the balance of the size of the printing image data 1200 that is the entire image, the lateral width x and vertical width y that are the size after dividing, and the shifting width z. For example, when X is 1000, Y is 500, x is 100, y is 100, and z is 10, 3731 divided images (91 in the X direction and 41 in the Y direction) are obtained. The divided image size may be decided by selecting a size with good precision out of a plurality of sizes at the time of learning, and a larger size is better if taking into consider higher speeds at the time of performing estimation using the same divided image size as at the time of learning. When presenting a more detailed position is desirable when presenting a defect portion in the estimating results, a smaller size of the divided image size is better, which will be described in detail later. Also, the smaller the shifting width z is, the higher the resolution is in a case of presenting results of detecting a defect, and accordingly the shifting width z may be made to be small in a case in which detecting a defect position with detail is desired.

Next, an example of data adjustment processing by the learning data generating portion 250 will be described. FIGS. 13A to 13C are application examples of data adjustment processing, and are examples of input data in the steps of data adjustment processing, processed by the learning data generating portion 250.

FIG. 13A is a table showing an example of input data subjected to processing in step S1121. As examples of parameters of input data that is data different from printing image data, cumulative printing time, ink concentration, temperature, humidity, media thickness, and media coating are listed. The table shows, in addition to these parameters, date and time, and printed article name. In step S1121, input data acquired from the printer 600 is first converted into a format in which parameter values corresponding to the same point in time (same date and time) are arrayed, as shown in FIG. 13A. Although the number of parameters has been narrowed to facilitate description, the parameters are not limited to those shown in FIG. 13A in actual practice, and all parameter data is arrayed. For the printed article name, the name of the printed article is entered if being printed, and if not being printed, either the space is left blank, or “none” or some other text string indicating that there is no printed article is entered. Whether the various types of parameter data at each point in time is for those being printed can be judged by the content of the printed article name. FIG. 13A shows an example in which one print is printed every three seconds, and the various types of parameter values are acquired every second. In this example, there is no flawed data at each printing time, and accordingly NO is returned in step S1122, and the flow advances to step S1123 without performing data interpolation processing.

FIG. 13B is a table showing an example of input data subjected to processing in step S1121, which is an example separate from that in FIG. 13A. In the example in FIG. 13B, there is flawed data at certain printing times, unlike the example in FIG. 13A. In this example, the cumulative printing time is acquired at five-second intervals, and the ink concentration, temperature, and humidity are acquired at two-second intervals. The acquisition timing of ink concentration and temperature is the same, but the acquisition timing of humidity is different. Also, the media thickness and the coating at the time of printing are entered for all points in time.

As long as data of all parameters is acquired, at all points in time, this will serve as learning data with no problem, but in a case in which there are points in time with no data, as shown in FIG. 13B, such dropout values are preferably adjusted before learning. Although there is a method for adjusting dropout values by deleting parameters with dropout values and data of a point in time at which even one dropout value exists, interpolation is performed in the first embodiment, to maximally increase the learning data. If it is known that the cumulative printing time is added in increments of seconds, dropout values can be calculated by adding the number of seconds of difference from the point in time that there is valid data. Ink concentration, temperature, and humidity are values of natures that gradually change, and accordingly preferably are interpolated by average values of valid data before and after the dropout value. In a case in which there is no data before or after, such as in the case of humidity, data of the nearest point in time can be used without change. By performing such interpolation processing, the data of FIG. 13B following data adjustment processing becomes equivalent to that of FIG. 13A.

Note that while average value processing using valid data before and after is used for processing dropout values in this example, other average value processing methods, or interpolation processing methods besides average value processing, can also be applied as long as the interpolation method is suitable for the data. Also, although description has been made regarding interpolation and so forth of dropout values with reference to FIG. 13B, being capable of acquiring all data at the same timing such that this sort of processing is unnecessary improves the quality of data, which is more desirable for improving learning precision. Also, an example of data becoming equivalent to that in FIG. 13A by interpolation processing in FIG. 13B has been described, but depending on the data before interpolation and the interpolation method, there are cases in which the data will not be completely the same.

FIG. 13C shows an example in which data outside of the printing time has been deleted in step S1123, to serve as learning data. Specifically, input data of which the printed article name is “none” in the example in FIG. 13A is deleted, since determination is made that data of a point in time at which printing is not being performed is unnecessary as input data.

### Association Processing of IDs and Labels

Next, the association processing of IDs and labels of step S1004 in the learning data generating flow in FIG. 10 will be described. FIGS. 14A to 14C are diagrams describing association processing of IDs and labels.

FIG. 14A illustrates three cutout ranges, for creating divided images with respect to printing image data 751, by dotted-line frames. A cutout range 1401 illustrated in FIG. 14A is a region at an upper left that is cut out first in the dividing processing, and a cutout range 1402 and a cutout range 1403 are regions toward the lower portion at the middle, that are cut out partway through the dividing processing. Also, the cutout range 1403 is a region that is shifted to the right from the cutout range 1402 by an amount corresponding to the shifting width z. In the present embodiment, the cutout range 1402 and the cutout range 1403 include the defect portion 752 that is a blank region.

FIG. 14B is association data of the IDs and the labels with respect to the divided images that are the input data for first trained model generation. The data shown in FIG. 14B includes, in addition to the ID and the label, printed article name, origin coordinates that are coordinates information of the divided images, divided image size, and divided image data name, but is not limited to these. Upon the image dividing processing ending, IDs are allocated to each of the divided images, and labels are imparted thereto. Labels are contents of results of performing labeling of whether each divided image is a normal region or an abnormal region that has a defect. For example, the divided image of the cutout range 1401 is a region that does not contain any defects, and accordingly is labeled as normal, while the cutout range 1402 and the cutout range 1403 are regions including the defect portion 752, and accordingly are labeled as abnormal. Accordingly, the labels are evaluation results of detects in the printed article, and are used as first teaching data of the first learning model. The labeling method can be manually performing labeling by visually confirming each divided image, or can be automated processing. As for the labeling method according to automated processing, coordinates information of a defect region can be managed prior to the image dividing processing, and coordinate regions of each piece of the divided image data, which can be found from coordinates information of each piece of divided image data, are labeled as abnormal if the coordinate region of the defect region is included therein, or the like.

Also, the printed article name, the origin coordinates and size of each divided image, the media type and thickness of the printed article, coating, and divided image data name, are managed at the same time with respect to the ID. Data associated with information other than the label for the ID may be managed as separate data. Note that the above-described content of association data of IDs and labels is only an example. Not all items listed above need to be included, and also information other than that described above can be included. However, at least the label and the divided image data name are preferably included. It is sufficient to be able to tell association of label information to each piece of divided image data, as far as learning is concerned.

Including coordinates information as data enables notification including the defect position in a case of performing notification of detection results of a defect. The coordinates information is not limited to origin coordinates and it is sufficient to be contents by which the coordinates of each divided image can be found uniquely. Also, divided image data may be stored in a data storage folder for normal and a data storage folder for abnormal, without compiling a list of association of IDs and labels. In this case, coordinates information is preferably included in the file name of the divided image data. Also, instead of saving as an image file, binary data may be added to the association data. Hereinafter, a case of saving as an image file will be described.

FIG. 14C is association data of IDs and labels with regard to the various types of parameters serving as input data for second trained model generation. The data shown in FIG. 14C includes, in addition to IDs and labels, printed article name, cumulative printing time, ink concentration, temperature, humidity, media thickness, and coating, but is not limited to these. Upon data adjustment processing ending, IDs are allocated instead of point in time data, and labels are imparted. The labels are labeled as normal if there is no defect in the entirety of printing image data acquired at the time of acquiring each piece of data, such as in the printing image data 750, and labeled as abnormal if there is even a partial defect region, as in the printing image data 751. The labels are evaluation results of defects in the printed article, as described above, and is also used as second teaching data for the second learning model. Also, an example is given in which the printed article name is also imparted as reference information, but this is not essential.

### Input/Output Structure of Learning Model at Time of Learning

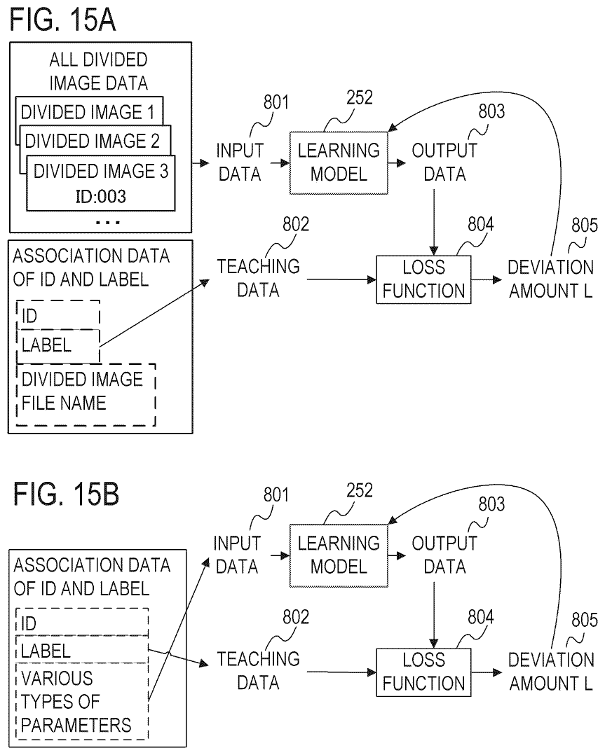

Next, the structure of input/output of the learning model 252 at the time of learning will be described. FIGS. 15A and 15B are diagrams illustrating the structure of input/output of the learning model 252 at the time of learning.

FIG. 15A illustrates the input/output structure of the first learning model for first trained model generation. As for the input data 801 (first input data) for learning of the first learning model, all divided image data of all printing image data is used. Also, as for the teaching data 802 (first teaching data) of the first learning model, label information included in the association data of IDs and labels is used. Learning is performed such that the deviation amount L between the output when inputting each divided image data to the learning model 252, and the label information that is the teaching data 802 corresponding to each divided image, is minimized, and the learning model 252 is updated.

The deviation amount L can be, for example, the difference between a defect probability of the output data 803 and a defect probability of the teaching data 802. In this case, a configuration is made in which the output data 803, when all divided image data is input as the input data 801, is output as a numerical value as the defect probability. The deviation amount L can be defined as above, by making a configuration in which the defect probability is acquired as a numerical value of 0% in the teaching data 802 when the label information is normal, and as defect probability of 100% when abnormal. Note that the method of defining the deviation amount L described here is one example, and it is sufficient for the deviation amount L to be something whereby these two numerical values can be compared. Also, correlation between the divided images and the labels can be acquired from the IDs or the like.

FIG. 15B illustrates the input/output structure of the second learning model for second trained model generation. All of the various types of parameter data are used as recording information relating to the printer 600 and the roll paper 3110 that is the recording medium, for the input data 801 (second input data) for learning of the second learning model. Also, label information included in association data of IDs and labels is used as the teaching data 802 (second teaching data) of the second learning model. That is to say, learning is performed such that the deviation amount L between the output when the various types of parameter data is input to the learning model 252 and the label information that is the teaching data 802 corresponding to the various types of parameter data is minimized, and the learning model 252 is updated.

The deviation amount L can be the difference between the defect probability of the output data 803 and the defect probability of the teaching data 802, in the same way as with the first learning model. In this case, a configuration is made in which the output data 803, when the various types of parameter data is input as the input data 801, is output as a numerical value as the defect probability. The deviation amount L can be defined as above, by making a configuration in which the defect probability is acquired as a numerical value of 0% in the teaching data 802 when the label information is normal, and as defect probability of 100% when abnormal. Note that the method of defining the deviation amount L described here is one example, and it is sufficient for the deviation amount L to be something whereby these two numerical values can be compared. Correlation between the various types of parameter data and the labels can be acquired from the IDs or the like.

Also, the input data 801 for learning does not have to be all of the various types of parameter data. Accordingly, the learning portion 251 can create and save each learning model 252 with respect to all combinations of input data in which one or a plurality of the various types of parameters are not input. By having such a plurality of learning models 252, even in cases in which not all of the various types of parameters can be acquired at the time of estimation, detection of defects can be performed with just the various types of parameter that could be acquired as input data.

### Operations of Processing System at Time of Estimating

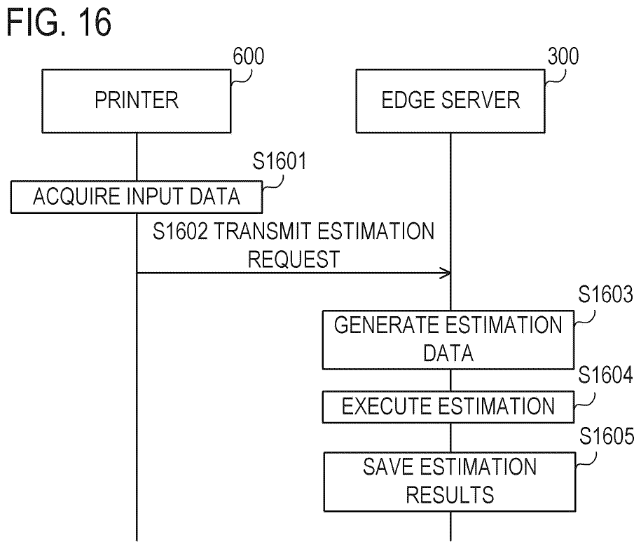

Next, operations of the processing system 100 at the time of estimating will be described. FIG. 16 is a sequence diagram showing operations of the overall processing system 100 at the time of estimating. This sequence is held in common between a case in of using the first trained model and a case of using the second trained model, and is equivalent to the operations of step S801 and step S802 in the defect detection of printed articles.

In the estimation processing performed by the processing system 100, first, in step S1601, input data that is the object of estimation is acquired at the printer 600. The input data for the first trained model is printing image data printed at the printer 600. The input data for the second trained model is the various types of parameters at the time of printing the actual printed articles on which the printing image data input to the first trained model is based. The input data for the second trained model is acquired in a format such as log data, including information of the various types of parameters in a period corresponding to a point in time of starting printing of the actual printed article to a point in time of ending the printing.

The various types of parameters data are preferably recorded at least one or more times during the printing time. Also, while the various types of parameters data is preferably recorded all at the same cycle, the cycle may be different for each parameter, in the same way as at the time of learning. Also, the printing time information of each printed article may be included in the various types of parameter data, or may be acquired separately from the various types of parameters data and associated with the various types of parameters data at a later time.

Judgment of acquisition of input data is performed by the data acquiring portion 451. Acquiring the printing image data and various types of parameters generated each time one print is printed while printing enables detection of defects in real-time while printing. Upon the input data being acquired in step S1601, an estimation request is transmitted from the printer 600 to the edge server 300 in step S1602. Upon the edge server 300 receiving the estimation request from the printer 600, in step S1603, the estimation data generating portion 351 generates estimation data. Details of generating the estimation data will be described later. Next, in step S1604, estimation is performed using the second trained model. In a case of using the first trained model, the output data 812 of the estimation results is the probability of the divided image data including a defect. Also, in a case of using the second trained model, the output data 812 of the estimation results is the probability that there is a defect in the printing image data acquired on the basis of a set of the various types of parameter data to which an ID is allocated. The estimation results that are acquired are saved in step S1605, and the processing ends.

### Estimation Data Generating Flow

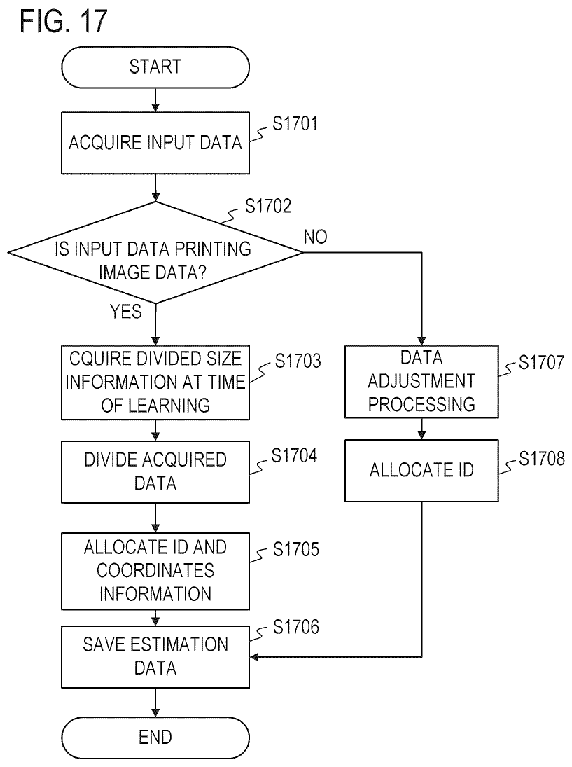

Next, an estimation data generating flow performed by the estimation data generating portion 351 will be described. FIG. 17 is a flowchart showing the estimation data generating flow that the estimation data generating portion 351 processes. Upon acquiring input data in step S1701, the estimation data generating portion 351 confirms contents of the input data in step S1702, and performs determination regarding whether or not the input data is printing image data for first trained model generation. In a case in which the input data is printing image data, i.e., YES is returned in step S1702, the flow advances to step S1703. In a case in which the input data is not printing image data, i.e., NO is returned in step S1702, the flow advances to step S1707. A case here in which the input data is not printing image data is, for example, a case in which the input data is data that includes various types of parameter data for second trained model generation.

In step S1703, the estimation data generating portion 351 acquires divided image size information from the time of learning, from the learning data generating portion 250 via the data collecting and providing portion 350. If the configuration is such that the divided image size is saved in the edge server 300 along with the trained model 353 in step S918 shown in FIG. 9, the estimation data generating portion 351 acquires this information. Upon step S1703 ending, the flow advances to step S1704.

In step S1704, the estimation data generating portion 351 divides the data that is acquired, using the same processing as in step S1003 in FIG. 10. The divided image data becomes the input data 811 to be input to the trained model 353. Upon step S1704 ending, the flow advances to step S1705.

In step S1705, the estimation data generating portion 351 allocates IDs and coordinates information to each piece of image data that has been divided, and performs association thereof. Association data for IDs and coordinates information will be described later. Upon step S1705 ending, the flow advances to step S1706. In this case, in step S1706, the estimation data generating portion 351 saves the divided image data and the association data for IDs and coordinates information, as estimation data.

In step S1707, the estimation data generating portion 351 performs adjustment processing of the various types of parameter data that is acquired. The data adjustment processing carried out here is the same processing as that in step S1006 in FIG. 10. Upon step S1707 ending, the flow advances to step S1708.

In step S1708, IDs are allocated in the same way as in step S1004 in FIG. 10. Upon step S1708 ending, the flow advances to step S1706. In this case, in step S1706, the estimation data generating portion 351 saves the association data of the various types of parameters and IDs as estimation data.

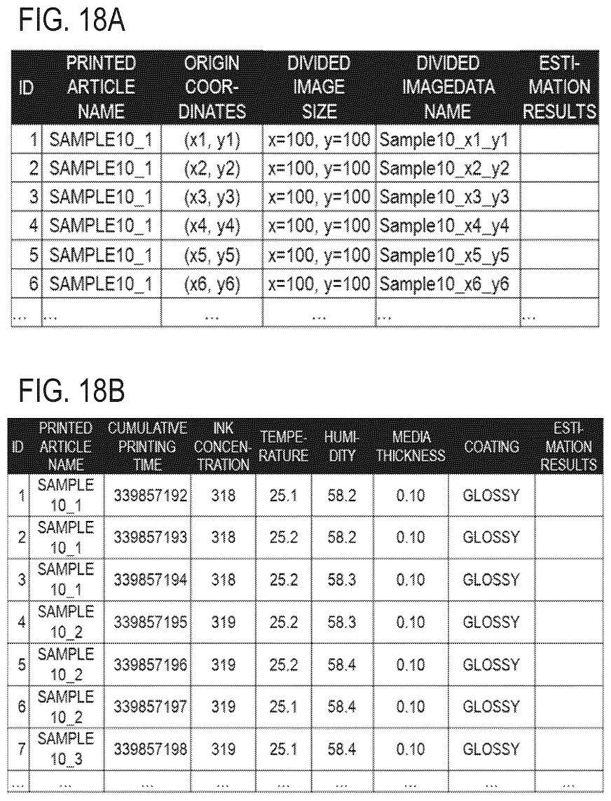

Next, an example of estimation data will be described. FIGS. 18A and 18B are examples of estimation data.

FIG. 18A is an example of estimation data for the first trained model. The data shown in FIG. 18A includes, in addition to the ID, the printed article name, origin coordinates that are coordinates information of the divided images, divided image size, divided image data name, and estimation results, but is not limited to these. Upon the image dividing processing ending, IDs are allocated to each of the divided images, and coordinates information is associated therewith. It is sufficient for the coordinates information to be contents by which the coordinates of each divided image can be found uniquely, and coordinates information may be included in the divided image data name and used as an ID. In a case of acquisition at the same time as the printing image data in step S1701, the printed article name is preferably managed in association with the ID. An estimation results space is a region for storing the probability of a defect being included in the printed article obtained as estimation results of each divided image, and the probability is stored with respect to each ID following executing estimation in step S1604.

FIG. 18B is an example of estimation data of the second trained model. The data shown in FIG. 18B includes, in addition to IDs, the printed article name, cumulative printing time, ink concentration, temperature, humidity, media thickness, coating, and estimation results, but is not limited to these. Upon data adjustment processing ending, IDs are allocated. In a case of acquisition at the same time as the various types of parameter data in step S1701, the printed article name is preferably managed in association with the ID. The estimation results space is a region for storing the probability of a defect being included in the printed article obtained from parameter data of each ID, and the probability is stored with respect to each ID following executing estimation in step S1604.

### Input/Output Structure of Trained Model at Time of Estimating

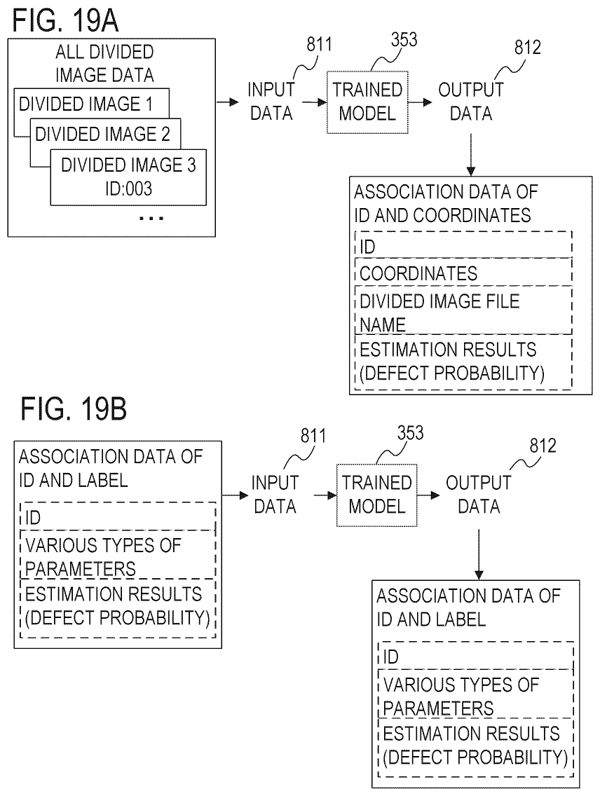

Next, the structure of input/output of the trained model 353 at the time of estimating will be described. FIGS. 19A and 19B are diagrams illustrating the structure of input/output of the trained model 353 at the time of estimating.

FIG. 19A illustrates an input/output structure at the time of estimation by the first trained model. As illustrated in FIG. 19A, all divided image data of the printing image data is used as the input data 811 (first estimation input data) for estimation by the first trained model. The output data 812 (first output data) obtained as a result of estimation performed by the trained model 353 (first trained model) is the probability of a defect that is estimated with respect to each piece of divided image data, and is saved associated with the ID of each piece of divided image data.

FIG. 19B illustrates an input/output structure at the time of estimation by the second trained model. As illustrated in FIG. 19B, the various types of parameter data is used as the input data 811 (second estimation input data) for estimation by the second trained model. For the various types of parameter data that is input, a dataset of IDs having the same printed article names as those used at the time of estimation by the first trained model is used out of the estimation data saved by the estimation data generating portion 351. In a case in which there are a plurality of datasets of IDs having the same printed article names, and a plurality of datasets of the various types of parameters at the same point in time are to be acquired, estimation is implemented for each of the data sets. The first embodiment is configured presuming that the printed article name is a name to uniquely define the printed article. However, in a case of permitting duplicative printed article names, printing point-in-time information and so forth can be included in estimation data, and datasets of IDs having the same printed article name and also printing point in time as those used at the time of estimation by the first trained model can be used.

The output data 812 (second output data) obtained as the result of estimation by the trained model 353 (second trained model) is the probability of a defect that is estimated with respect to the set of the various types of parameter data, and is saved associated with the ID of the various types of parameter data. Now, in a case in which not all of the various types of parameter data is included in the various types of parameter data serving as the input data 811, the estimating portion 352 selects the trained model 353 in accordance with the contents of the various types of parameter data acquired. A trained model in accordance with the contents of the various types of parameter data that is generated by the learning portion 251 and saved, is used.

### Estimation Results Evaluation by Estimation Results Evaluating Portion

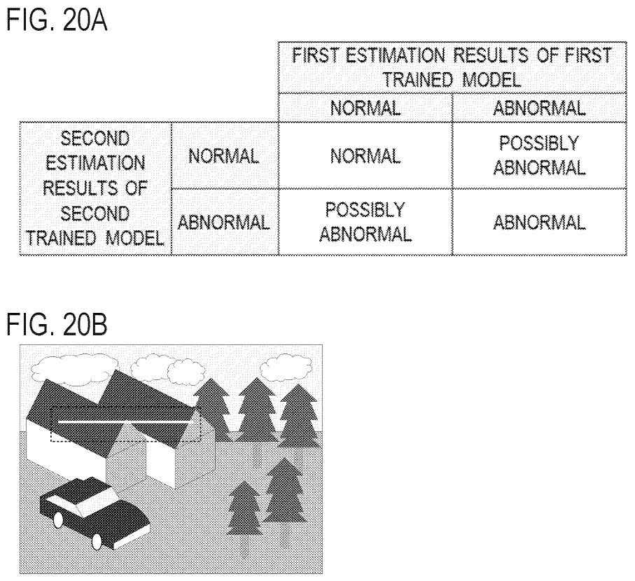

Next, an estimation results evaluating method regarding whether or not a printed article contains a defect, performed by the estimation results evaluating portion 354, will be described. This evaluation by the estimation results evaluating portion 354 is equivalent to decision of whether or not there is a defect in step S803 in FIG. 8. FIGS. 20A and 20B are explanatory diagrams processing contents carried out by the estimation results evaluating portion 354.

FIG. 20A shows an evaluation table of final results of estimation that the estimation results evaluating portion 354 uses for processing. The estimation results evaluating portion 354 according to the first embodiment decides final defect determination results regarding certain printing image data (printed article) from first estimation results from the first trained model and second estimation results from the second trained model.

First, the estimation results evaluating portion 354 decides final results of estimation of each of the first estimating portion that uses the first trained model and the second estimating portion that uses the second trained model. The final results of estimation of each is decided on the basis of whether or not a defect probability acquired by each as output data is no lower than a predetermined threshold value. The final results of estimation by the first estimating portion change in accordance with whether or not the defect probability is no lower than a first threshold value (50% in this example). The estimation results evaluating portion 354 according to the first embodiment decides that the first estimation results are abnormal in a case of determining that the defect probability regarding one or more pieces of divided image data is no lower than 50% with respect to the divided image data of the printing image data acquired by the first trained model. Conversely, first estimation results by the first trained model are decided to be normal if the defect probability is lower than 50% for all pieces of divided image data. In this way, the estimation results evaluating portion 354 determines whether the first estimation results by the first trained model are normal or abnormal, on the basis of the defect probability that is the output data 812 of the first trained model.

The final results of estimation by the second estimating portion change depending on whether the defect probability is no lower than a second threshold value (50% in this example). Also, the estimation results evaluating portion 354 changes the deciding processing of the estimation results by the second trained model in accordance with the number of datasets of the various types of parameter data at the time of printing the printed article that is the basis for the printing image data used at the time of estimation by the first trained model. In a case in which the number of datasets of the relevant various types of parameter data is one, and the defect probability regarding that dataset is determined to be no lower than 50%, the second estimation results are decided to be abnormal, but the second estimation results are decided to be normal if lower than 50%. In a case in which the number of datasets of the relevant various types of parameter data is plural, and the defect probability regarding one or more datasets is determined to be no lower than 50%, the second estimation results are decided to be abnormal, but the second estimation results are decided to be normal if all are lower than 50%. In this way, the estimation results evaluating portion 354 determines whether the second estimation results of the second trained model are normal or abnormal, on the basis of the defect probability that is the output data 812 of the second trained model. Note that while 50% is set as a suitable example of the first threshold value and the second threshold value in this example, the numerical values of each can be freely changed, and may be user-settable values.

Next, the estimation results evaluating portion 354 references an evaluation table, and decides final defect determination results from combinations of estimation results of the trained models. The final defect determination results are notified to the printer 600 in step S804, and the printer operates in accordance with the contents notified thereto.

### Case of First Estimation Results Normal, and Second Estimation Results Normal

In the first embodiment, in a case in which both estimation results of the first trained model and the second trained model are normal, the estimation results evaluating portion 354 decides the final results as being normal. In this case, printing can be continued with the quality of printing guaranteed. Accordingly, only notification to the effect that the printed article is normal is made in step S804. Upon receiving this notification, the printer 600 may do nothing in particular, or can perform an operation such as making a display to the effect that the printed article is normal on a user interface, saving information to the effect that the printed article is normal as history with respect to the printed article name, or the like.

### Case of First Estimation Results Abnormal, and Second Estimation Results Abnormal

Also, in a case in which both estimation results of the first trained model and the second trained model are abnormal, the estimation results evaluating portion 354 decides the final results as being abnormal. In step S804, notification is made that there is a defect in the printed article, notification of detailed information is also made, and data is also transmitted as necessary.

In a case in which the final results are abnormal, printing cannot be continued with the quality of printing guaranteed. Accordingly, upon receiving a notification of abnormal, in a case in which printing is continuing, the printer 600 immediately stops the printing operations (recording operations) being executed. Also, in a case in which there is notification of a coordinates range for the defect portion in the printing image data, the printer 600 can visualize the defect portion in the printing image data from this information, and present the user therewith on the user interface displayed on the operating panel, or the like. The coordinate range of the defect portion can be created from the coordinates information of the divided image data of which the defect probability is determined to be no lower than 50%.

FIG. 20B is an example of visualizing the defect portion in the printing image data with a dotted-line frame. By displaying such an image on the user interface along with a message such as “Printing defect detected” or the like enables the user to recognize not only that a defect has occurred, but to recognize the defect portion as well. The user who has viewed this display can remove the printed article with the defect, and then perform maintenance work such that the printer 600 can print normally.

Such maintenance work can be automated. For example, in a case in which a defect is found in the relevant printed article, the printer 600 operates to automatically remove the relevant printed article to a trash bin or the like. Further, a nozzle region of a head discharging to the relevant region can be found from the coordinates range of the divided image data of which the defect probability has been determined to be no lower than 50% by estimation by the first trained model. Accordingly, automated maintenance of nozzles that are possibly the cause of the defect can be executed.

Also, in a case of having used a model that can acquire a degree of importance of features at the time of estimation by the second trained model, parameter data contributing to the abnormal determination can be identified. Accordingly, in a case in which temperature or humidity is contributing to the abnormal determination, for example, notification can be made to the effect that the temperature or humidity is exhibiting an abnormal value, and the value thereof. In a case in which parameters relating to the media are contributing to the abnormal determination, replacing the media or the like can be proposed. In a case in which parameters relating to the conveying path are contributing to the abnormal determination, adjustment of the conveying path for the media, and so forth, can be proposed.

The notification contents described here are an example, and anything can be notified as long as results of the trained models can be understood. Also, the operations of the printer 600 under notification from the estimation results evaluating portion 354 are an example, and other operations can be performed or set by the user from the user interface, or the like.

### Case of First Estimation Results Abnormal, and Second Estimation Results Normal

In a case in which the estimation results of the first trained model are abnormal, and the estimation results of the second trained model are normal, the estimation results evaluating portion 354 decides the final results to be possibly abnormal. In step S804, notification is made that there possibly is a defect in the printed article, notification of detailed information is also made, and data is also transmitted as necessary. In this case, there is a possibility of a region in the printing image data that does not have a defect is being erroneously detected as having a defect, and accordingly the printer 600 does not have to immediately stop printing if currently printing. However, there also is a possibility that a defect in the printing image data is being correctly detected. Accordingly, the portion where there is possibly a defect in the printing image data is preferably displayed to the user, in the same way as when both trained models make abnormal determinations. The user can confirm whether there is a defect, visually or otherwise, and can carry out maintenance work or the like if there actually is a defect.

### Case of First Estimation Results Normal, and Second Estimation Results Abnormal

In a case in which the first estimation results of the first trained model are normal, and the second estimation results of the second trained model are abnormal, the estimation results evaluating portion 354 decides the final results to be possibly abnormal. In step S804, notification is made that there possibly is a defect in the printed article, notification of detailed information is also made, and data is also transmitted as necessary. In this case, while the likelihood of a defect in the printed article itself is low, there is a possibility of the various types of parameter data affecting the printed article itself shortly, or a possibility of items other than the printed article itself being affected. In a case of having used a model that can acquire a degree of importance of features at the time of estimation by the second trained model, parameter data contributing to the abnormal determination can be identified. Accordingly, in step S804 notification is made to the effect that defects may possibly occur shortly in printed articles, and notification is also made of information of parameter data contributing to the abnormal determination and that there is a possibility of a device abnormality. The printer 600 can make a display of the notification contents that are received to the user, and in a case in which the parameters contributing to the abnormal determination are parameters caused by wear of components of the printer 600, can prompt replacement of the components, and so forth.

### Second Embodiment

Next, a second embodiment according to the present disclosure will be described. The second embodiment differs from the first embodiment with respect to the determination method of final results in defect detection of the printed article. Hereinafter, in description of the second embodiment, configurations and processing that are the same as in the first embodiment are denoted by the same signs and description thereof will be omitted, and only feature configurations of the second embodiment will be described.

In the first embodiment, processing is performed in which both the first trained model and the second trained model are used at all times at the time of defect detection using the trained model 353. Conversely, a case will be described in the second embodiment in which estimation of defects is executed by the second trained model, and the estimation of defects is performed by the first trained model depending on conditions. Estimation by the first trained model involves image acquisition and image processing, and accordingly the processing load is higher. Accordingly, there can be cases in which real-time detection of defects during printing cannot keep up, depending on the printing speed, and cases in which reducing the load is desired depending on the configuration of the processing system. In such cases, a configuration is preferable in which only estimation of defects by the second trained model, which does not involve image acquisition and image processing, is executed at all times. Note that processing contents by the edge server 300 and the cloud server 200, the contents in the sequence diagrams at the time of learning and at the time of estimating by the processing system 100, and so forth, according to the second embodiment, are the same as those in the above first embodiment, and accordingly description will be omitted here.

### Flow for Detecting Defects in Printed Articles

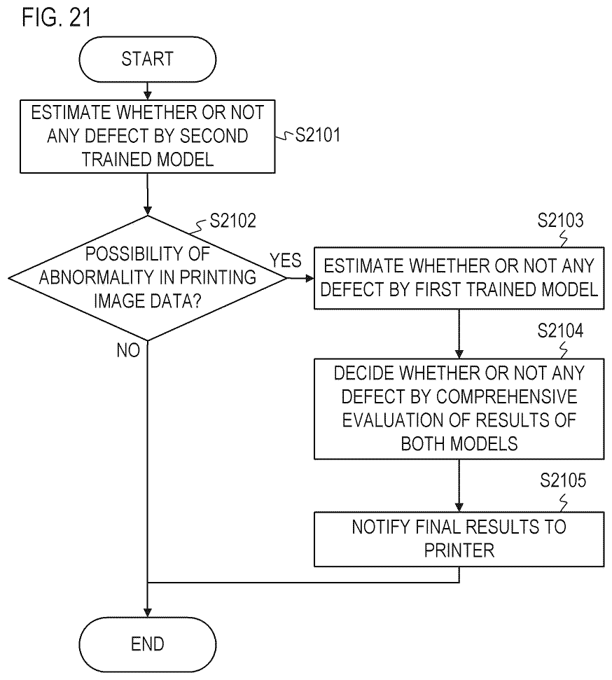

A processing flow for detecting defects in printed articles (actual printing results) of the printer 600 by the processing system 100 according to the second embodiment will be described. FIG. 21 is a flowchart showing an overview of defect detection performed by the processing system 100 according to the second embodiment.

First, in step S2101, the processing system 100 estimates whether or not there is a defect in a printed article at the time of printing, by the second trained model that takes, as input thereof, various types of parameters regarding when printing the actual printed article, and acquires second estimation results.

Next, whether or not there is a defect in the printed article is determined in step S2102 on the basis of the second estimation results. In a case in which the defect probability is lower than 50% in the second estimation results from the second trained model, i.e., in a case in which NO is returned in step S2102, determination is made that the printing image data printed on the printed article is normal, and the processing ends.

Conversely, in a case in which there is one or more items of which the defect probability is no lower than 50% with respect to the second estimation results from the second trained model, i.e., in a case in which YES is returned in step S2102, determination is made that there is a possibility of abnormality in the printing image data printed on the printed article, and the flow advances to step S2103.

In step S2103, estimation is made whether or not there is a defect in the printed article, by the first trained model that takes the printing image data as input thereof, and first estimation results are acquired. In a case in which the printer 600 executes acquisition of printing image data at all times, the printing image data saved at this point is acquired. However, in a case in which the printer 600 does not execute acquisition of printing image data at all times, there is a need to create the printing image data to be taken as input data at this point. Upon step S2103 ending, the flow advances to step S2104.

Note that in a case of a configuration in which the printer 600 does not execute acquisition and saving of printing image data at all times, acquisition of estimation results by the second trained model prior to scanning the printing image data is preferable. That is to say, estimation by the second trained model is preferably completed during the time of the recording medium being conveyed from the printing portion that carries out printing to the scanner portion that acquires the printing image data. Accordingly, in a case of such a configuration, the conveying distance and the conveying speed of the recording medium from the printing portion to the scanner portion are preferably decided taking into consideration the estimating time by the second trained model, in the hardware configuration of the printer 600. If execution of the estimation by the second trained model is started immediately after printing is performed at the printing portion, and the estimation is complete by the time of reaching the scanner portion, the printing image data can be promptly acquired at the scanner portion in a case in which the estimation results are that there is a defect.

In step S2104, the estimation results evaluating portion 354 decides the final defect determination results by processing similar to that in the first embodiment, and in step S2105, notifies the printer 600 of the results. Note that although a processing flow is described in the second embodiment in which the printer 600 is not notified in a case in which judgment of normal is made in step S2102, this is not restrictive. For example, a configuration may be made in which the printer 600 is notified to the effect that the results are normal, and information to the effect that the printer 600 was normal is used as data and the like for saving history.

### Third Embodiment

Next, a third embodiment according to the present disclosure will be described. The third embodiment differs from the first and second embodiments with respect to the determination method of final results in defect detection of the printed article. Hereinafter, in description of the third embodiment, configurations and processing that are the same as in the first embodiment are denoted by the same signs and description thereof will be omitted, and only feature configurations of the third embodiment will be described.

In the third embodiment, opposite to the second embodiment, estimation of defects is first executed by the first trained model, and depending on the results thereof, estimation of defects is then executed by the second trained model. In the first embodiment, estimation of whether or not there are defects in the printed article, performed by the second trained model, is carried out at all times, with one object thereof being preventing erroneous detection of defects in the printed article by the first trained model. That is to say, in a case in which the first estimation results by the first trained model are abnormal (there is a defect), additional estimation by the second trained model should be performed, but is not essential in a case in which the estimation results by the first trained model are that there are no defects. Note that processing contents by the edge server 300 and the cloud server 200, the contents in the sequence diagrams at the time of learning and at the time of estimating by the processing system 100, and so forth, according to the third embodiment, are the same as those in the above first embodiment, and accordingly description will be omitted here.

### Flow for Detecting Defects in Printed Articles

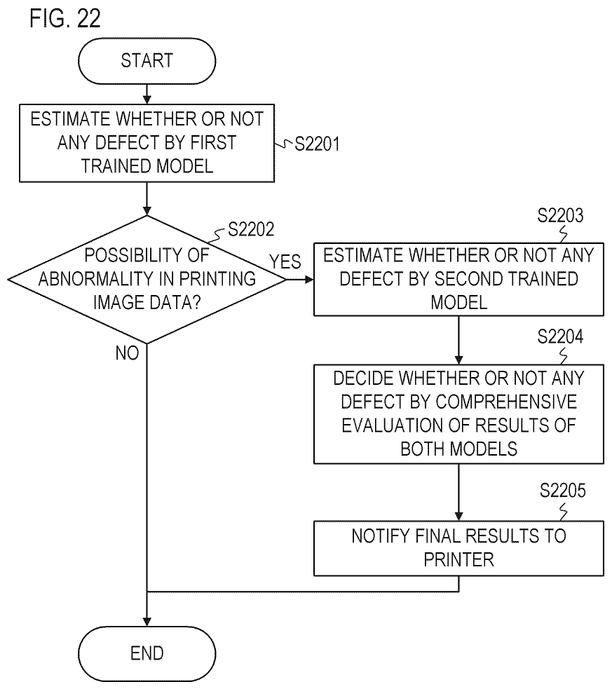

A processing flow for detecting defects in printed articles (actual printing results) of the printer 600 by the processing system 100 according to the third embodiment will be described. FIG. 22 is a flowchart showing an overview of defect detection performed by the processing system 100 according to the third embodiment.

First, in step S2201, the processing system 100 estimates whether or not there is a defect in a printed article at the time of printing, by the first trained model that takes the printing image data as input thereof, and acquires first estimation results.

Next, whether or not there is a defect in the printed article is determined in step S2202 on the basis of the first estimation results. In a case in which the defect probability is lower than 50% in the first estimation results from the first trained model, i.e., in a case in which NO is returned in step S2202, determination is made that the printing image data printed on the printed article is normal, and the processing ends.

Conversely, in a case in which there is one or more pieces of divided image data of which the defect probability is no lower than 50% with respect to the first estimation results from the first trained model, i.e., in a case in which YES is returned in step S2202, determination is made that there is a possibility of abnormality in the printing image data printed on the printed article, and the flow advances to step S2203.

In step S2203, estimation is made whether or not there is a defect in the printed article, by the second trained model that that takes, as input thereof, various types of parameters regarding when printing the actual printed article, and second estimation results are acquired. The printer 600 is of a configuration that saves data such as log data including the various types of parameter data, at all times, and data such as log data including the various types of parameter data at the time of printing the relevant actual printed article is acquired at this point. Upon step S2203 ending, the flow advances to step S2204.

In step S2204, the estimation results evaluating portion 354 decides the final defect determination results by processing similar to that in the first embodiment, and in step S2205, notifies the printer 600 of the results. Note that although a processing flow is described in the third embodiment in which the printer 600 is not notified in a case in which judgment of normal is made in step S2202, this is not restrictive. For example, a configuration may be made in which the printer 600 is notified to the effect that the results are normal, and information to the effect that the printer 600 was normal is used as data and the like for saving history.

As described above, according to the above-described configurations, whether or not there are defects in printed articles is estimated by a trained model subjected to machine learning, on the basis of data relating to various types of parameters when printing an actual printed article, in addition to printing image data, and accordingly defects can be detected with high precision, with respect to a broader range of types of printed articles. Data that is different from the printing image data can be used for defect detection of printed articles, and accordingly deterioration of detection precision of detects can be suppressed regarding printing image data of a different nature from printing image data used as input data at the time of learning by machine learning. Furthermore, defects in printed articles can be detected with high precision.

Note that while the first embodiment, the second embodiment, and the third embodiment have been described so far, which configuration to employ in the processing system 100 can be freely chosen. Also, in a configuration that can selectively employee any of the configurations, the user may perform manual selection, or the processing system 100 may automatically make judgment. In a case of the user selecting, the processing system 100 switches processing by the user performing selection at the user interface displayed on the operating panel 605. Also, in a case of automatically judging, for example, a configuration may be made in which the processing of the first embodiment is basically used, but is switched to the second embodiment in a case of a state in which the overall load on the processing system 100 is great.

Also, while machine learning models are used in detection of defects by various types of parameter data, in a case in which parameters that take an abnormal value when defects occur in printed articles are clearly known, using the values of such parameters alone for detection of defects, without using machine learning models, is conceivable. According to such a configuration, the processing load of using two machine learning models can be reduced. However, there are a great many parameters that can cause detects in printed articles, and are intricately involved with one another, and accordingly using machine learning models is preferable. Also, a configuration may be made in which estimation of defect probability is performed for part of the parameters out of the input data of the second trained model, and when the results are a certain level or higher, perform estimation of defect probability for the other parameters.

### OTHER EMBODIMENTS

The present disclosure can also be realized by processing in which a program that realizes functions of one or more of the above-described embodiments is supplied to a system or a device via a network or a storage medium, and the computer of the system or the device reads out and executes the program. The computer can have one or a plurality of processors or circuits, and include a network of a plurality of separate computers or a plurality of separate processors or circuits, in order to read out and execute computer-executable commands. In other words, the image inspection system can be configured by comprising one or more memories storing one or more programs which include instructions such as storing the first and second trained models and acquiring the first and second probabilities and the first and second estimation results.

The processors or circuits can include a central processing unit (CPU), a micro processing unit (MPU), a graphics processing unit (GPU), an application-specific integrated circuit (ASIC), and a field-programmable gate array (FPGA). The processors or circuits can also include a digital signal processor (DSP), a data flow processor (DFP), and a neural processing unit (NPU).

The storage medium can also be referred to as a non-transitory computer-readable medium. Also, the storage medium can include storage devices of one or a plurality of hard disks (HD), random access memory (RAM), read-only memory (ROM), and a distributed computing system. The storage medium can also include an optical disc (e.g., compact disc (CD), digital versatile disc (DVD), or Blu-ray disc (BD, registered trademark), a flash memory device, and a memory card.

Also, in application of the present disclosure, processing described in the above embodiments as being performed by a single device may be shared and executed by a plurality of devices. Alternately, processing described as being performed by different devices may be executed by a signal device. What sort of hardware configuration to realize the function within the computer system can be flexibly changed.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-206752, filed on Dec. 7, 2023, which is hereby incorporated by reference herein in its entirety.

What is claimed is:

1. An image inspection system inspecting an image recorded on a recording medium by a recording device, the image inspection system comprising:
one or more hardware processors; and
one or more memories storing one or more programs configured to be executed by the one or more hardware processors, the one or more programs including instructions for:
storing a first trained model that is generated by machine learning based on learning recorded images that are images for machine learning, recorded on recording media;
storing a second trained model that is generated by machine learning based on recording information that is different from the learning recorded images and that is information relating to at least one of the recording device and the recording medium at a time of recording the learning recorded images;
acquiring a first probability of a defect being in an actual recorded image that is an object of inspection by the first trained model;
acquiring a first estimation result that is an evaluation result regarding whether the actual recorded image is normal or abnormal by a first estimating portion on the basis of the first probability;
acquiring a second probability of a defect being in the actual recorded image by the second trained model;
acquiring a second estimation result that is an evaluation result regarding whether the actual recorded image is normal or abnormal by a second estimating portion; and
detecting a defect in the actual recorded image on the basis of the first estimation result and the second estimation result.

2. The image inspection system according to claim 1,
wherein in a case in which the first probability is no lower than a first threshold value, the first estimating portion sets the first estimation result to the effect that the actual recorded image has an abnormality, and in a case in which the second probability is no lower than a second threshold value, the second estimating portion sets the second estimation result to the effect that the actual recorded image has an abnormality.

3. The image inspection system according to claim 2,
wherein the first threshold value and the second threshold value are 50%.

4. The image inspection system according to claim 1,
wherein the first trained model is generated by machine learning based on the learning recorded images and an evaluation result regarding whether the learning recorded images are normal or abnormal, and
wherein the evaluation result is data in which a probability of a defect being in the actual recorded image is 100% in a case in which the recorded image is abnormal, and is data in which a probability of a defect being in the actual recorded image is 0% in a case in which the recorded image is normal.

5. The image inspection system according to claim 1, further comprising:
a data generating portion that divides image data acquired from the actual recorded image into a plurality and generates divided image data,
wherein the first estimating portion estimates whether each of the plurality of the divided image data is normal or abnormal, and acquires the first estimation result on the basis of the estimation results thereof.

6. The image inspection system according to claim 5,
wherein the data generating portion divides the image data of the actual recorded image by a predetermined vertical width, a predetermined lateral width, and a predetermined shifting amount, and generates the divided image data.

7. The image inspection system according to claim 5,
wherein, when it is determined that one or more pieces of the divided image data is abnormal, the first estimating portion decides that the first estimation result indicates that the actual recorded image has an abnormality.

8. The image inspection system according to claim 1,
wherein the recording information includes at least one of ink concentration at a time of recording the image, environment temperature, environment humidity, thickness of an actual recording medium on which the actual recorded image is recorded, and coating type of the actual recording medium.

9. The image inspection system according to claim 1,
wherein the recording information includes at least one of position information of a liquid discharge head that discharges liquid, which the recording device is equipped with, at a time of recording the image, count of times of cleaning a nozzle of the liquid discharge head, and a roller diameter of a roller making up a conveying path for the recording medium, which the recording device is equipped with.

10. The image inspection system according to claim 1,
wherein the second estimating portion includes the recording information at a plurality of points in time at time of recording the image.

11. The image inspection system according to claim 10,
wherein the second estimating portion estimates whether or not each of the recording information at the plurality of points in time is normal, and acquires the second estimation result on the basis of the estimation results thereof.

12. The image inspection system according to claim 11,
wherein, when it is determined that one or more pieces of recording information of the recording information at the plurality of points in time is abnormal, the second estimating portion decides that the second estimation result is to the effect that the actual recorded image has an abnormality.

13. The image inspection system according to claim 1,
wherein, when both the first estimation result and the second estimation result are determined to be abnormal, the image inspection system notifies a user that there is a defect in the actual recorded image.

14. The image inspection system according to claim 13,
wherein, when there is a defect in the actual recorded image, the image inspection system notifies a user of a defect portion being present.

15. The image inspection system according to claim 1,
wherein, when both the first estimation result and second estimation result is abnormal, recording operations being executed by the recording device are stopped.

16. The image inspection system according to claim 1,
wherein, when the first estimation result is abnormal and the second estimation result is normal, or when the first estimation result is normal and the second estimation result is abnormal, the image inspection system notifies a user that a defect may be present in the actual recorded image.

17. The image inspection system according to claim 1,
wherein, when the first estimation result is abnormal and the second estimation result is normal, the image inspection system notifies a user that a defect portion in the image data of the actual recorded is present.

18. The image inspection system according to claim 1,
wherein, in a case in which the first estimation result is normal and the second estimation result is abnormal, the image inspection system notifies a user of information representing parameter data that contributes to the abnormal determination.

19. The image inspection system according to claim 1,
wherein, when the first estimation result is abnormal, the second estimating portion acquires the second estimation result.
